(19) United States
(12) Patent Application Publication
(10) Pub. No.: US 2020/0071644 A1
(43) Pub. Date: Mar. 5, 2020

(54) FIBROUS STRUCTURES COMPRISING PARTICLES AND METHODS FOR MAKING THE SAME

(71) Applicant: The Procter & Gamble Company, Cincinnati, OH (US)

(72) Inventors: Mark Robert SIVIK, Mason, OH (US); Frank William DENOME, Cincinnati, OH (US); Paul R. MORT, III, Cincinnati, OH (US)

(21) Appl. No.: 16/121,714

(22) Filed: Sep. 5, 2018

(51) Int. Cl. C11D 17/04; C11D 3/37; C11D 1/29; C11D 1/14

(52) U.S. Cl. CPC C11D 17/044; C11D 3/3757; C11D 3/3788; C11D 3/3723; C11D 3/3907; C11D 3/3707; C11D 1/29; C11D 1/146; C11D 3/3753

(57) ABSTRACT

Described herein is a household care composition, which delivers active agents onto fabric or hard surfaces, in the form of a water-soluble unit dose article comprising a water-soluble fibrous structure and one or more particles, as well as methods for making the same.

### FIELD OF THE INVENTION

Described herein is a household care composition which delivers active agents onto fabric or hard surfaces in the form of water-soluble unit dose articles comprising a water-soluble fibrous structure and a plurality of particles, as well as methods for making the same.

### BACKGROUND OF THE INVENTION

There is considerable interest within the detergent industry concerning formulating household detergents that have the convenience, aesthetics, and solubility of liquid detergent products, but that retain the cleaning performance and cost of granular detergent products, especially those with bleach activators and other active agents. To provide such convenience, detergent manufacturers have introduced water-soluble unit dose articles to consumers. Water-soluble unit dose articles are desired by consumers as they provide a convenient, efficient, and clean way of dosing a treatment composition. Water-soluble unit dose articles provide a measured dosage of a treatment composition, thereby avoiding over or under dosing. Various kinds of water-soluble unit dose articles are known, including articles constructed of a water-soluble film shaped to provide at least one internal compartment, where the compartment contains a solid and/or liquid detergent composition. Water-soluble unit dose articles are expected to fully dissolve when placed in the wash and for the active agents contained within to be effectively dispersed within the wash.

One obstacle in formulating concentrated unit dose articles is the inclusion of different active agents within the small space of the article when certain active agents are incompatible upon direct interaction with one another. To circumvent this problem, placing active agents within discrete particles may keep incompatible active agents from coming into direct interaction with one another, as compared to, for example, singular all-liquid compositions. Oftentimes the particles are interspersed within the unit dose article, such as when the article is composed of fibers or other solid materials, or may be placed within a separate compartment within the unit dose article when the unit dose article has multiple compartments. The particles used are typically smaller in size, generally where the particles have a particle size distribution such that the D50 particle size is less than 1 mm as measured according to the Granular Size Distribution Test Method described herein. Smaller particles can be an effective way to keep incompatible agents from coming into direct interaction with one another while fitting within the finite confines of the unit dose article.

Formulators must still incorporate a minimum level of each active agent to provide a satisfactory consumer experience. Each particle is limited as to the amount of active agent it may hold. Thus, formulators must increase the quantity of smaller-sized particles as to ensure that a minimum level of each active agent is incorporated within the unit dose article. Increasing the quantity of particles, even though smaller in size, means more of the particles are packed closer in proximity with one another within the finite confines of the unit dose article. A large quantity of tightly packed particles becomes problematic when the article needs to dissolve quickly and effectively disperse the active agents. Upon coming into contact with water, wetting of the tightly packed smaller particles may lead to lumpy, gel-like structures (or “gelling”) where the particles clump together and cannot be effectively dispersed within the wash. Inhibited dispersion and dissolution of active agents may affect the consumer experience as the active agents are unable to effectively clean the items to be cleaned and product is wasted.

As such, there is a need for a water-soluble unit dose article having active agent containing particles where the unit dose article readily dissolves when placed in the wash without gelling while still providing a satisfactory consumer experience with regards to satisfactory cleaning power and high value perception.

### SUMMARY OF THE INVENTION

The present disclosure relates to a water-soluble unit dose article comprising a water-soluble fibrous structure and a plurality of particles associated with the water-soluble fibrous structure, wherein the plurality of particles has a particle size distribution such that the D50 particle size is from about 1 mm to about 4.75 mm, as measured according to the Granular Size Distribution Test Method, and wherein the water-soluble fibrous structure further comprises a plurality of fibrous elements.

The present disclosure also relates to a method of making a water-soluble unit dose article, the method comprising the steps of: a) providing a water-soluble first ply; b) providing a water-soluble second ply, wherein the water-soluble second ply is separate from the water-soluble first ply; c) providing a plurality of particles; d) associating the plurality of particles with the water-soluble first ply and/or the water-soluble second ply; e) superposing the water-soluble first ply and the water-soluble second ply; and f) joining a portion of the water-soluble first ply to a portion of the water-soluble second ply to form the water-soluble unit dose article, wherein the plurality of particles is contained within the water-soluble unit dose article, and wherein the plurality of particles has a particle size distribution such that the D50 particle size is from about 1 mm to about 4.75 mm, as measured according to the Granular Size Distribution Test Method.

The present disclosure also relates to a method of treating a substrate using a water-soluble unit dose article, the method comprising the steps of: providing a water-soluble unit dose article and contacting the water-soluble unit dose article with one or more substrates to be treated, wherein the water-soluble unit dose article comprises a water-soluble fibrous structure and a plurality of particles associated with the water-soluble fibrous structure, wherein the plurality of particles has a particle size distribution such that the D50 particle size is from about 1 mm to about 4.75 mm, as measured according to the Granular Size Distribution Test Method, and wherein the water-soluble fibrous structure further comprises a plurality of fibrous elements.

### BRIEF DESCRIPTION OF THE DRAWINGS

FIG. 1 is a perspective view of a water-soluble unit dose article.

FIG. 2 is a cross-sectional perspective view of a ply having two layers.

FIG. 3 is a schematic representation of a cross-sectional view of an example of a multiply fibrous structure having particles.

FIG. 4 is a manufacturing line for making plies.

FIG. 5 is a second ply being joined to a first ply to form a water-soluble unit dose article.

FIG. 6 is a side view of a two-ply water-soluble unit dose article.

### DETAILED DESCRIPTION OF THE INVENTION

The present disclosure relates to a water-soluble unit dose article comprising a water-soluble fibrous structure and a plurality of particles associated with the water-soluble fibrous structure, wherein the plurality of particles has a particle size distribution such that the D50 particle size is from about 1 mm to about 4.5 mm as measured according to the Granular Size Distribution Test Method. The fibrous structure further comprises a plurality of fibrous elements.

The present disclosure also relates to a method of making a water-soluble unit dose article, the method comprising the steps of: a) providing a water-soluble first ply; b) providing a water-soluble second ply, wherein the water-soluble second ply is separate from the water-soluble first ply; c) providing a plurality of particles; d) associating the plurality of particles with the water-soluble first ply and/or the water-soluble second ply; e) superposing the water-soluble first ply and the water-soluble second ply; and f) joining a portion of the water-soluble first ply to a portion of the water-soluble second ply to form the water-soluble unit dose article, wherein the plurality of particles is contained within the water-soluble unit dose article, and wherein the plurality of particles has a particle size distribution such that the D50 particle size is from about 1 mm to about 4.75 mm, as measured according to the Granular Size Distribution Test Method.

The present disclosure also relates to a method of treating a substrate using a water-soluble unit dose article, the method comprising the steps of: providing a water-soluble unit dose article according to the present disclosure and contacting the water-soluble unit dose article with one or more substrates to be treated.

Without wishing to be bound by theory, it has been found that incorporating particles of the present disclosure into water-soluble unit dose articles (e.g., laundry detergent articles) may allow for effective distribution of active agents contained within the particles during a washing operation, as the particles may be placed within the finite space of the unit dose article in such a formation where incompatible active agents avoid directly interacting with one another (such particles characterized by having a particle size distribution such that the D50 particle size is from about 1 mm to about 4.75 mm, as measured according to the Granular Size Distribution Test Method). An example of incompatible active agents that may lose effectiveness when coming into direct interaction with one another is that of enzymes and surfactants. Enzymes and surfactants are two components that provide exceptional benefits for use in laundering fabric. It is well-known that enzymes may be prone to degradation especially when interacting with surfactants. Formulators may include components such as solvents to keep the enzymes from denaturing when the enzymes come into direct interaction with the surfactants, such as when both are placed within a liquid laundry detergent or within the same compartment of a unit dose article. When the enzymes and/or surfactants are placed within particles, the enzyme is no longer in direct interaction with the surfactant. These particles may still contain the levels of enzymes and/or surfactant necessary to provide a satisfactory experience while still maintaining sufficient separation to inhibit direct interaction with each other.

Another such benefit of incorporating such particles into water-soluble unit dose articles is that water-soluble unit dose articles may more effectively dissolve in the wash and disperse active agents without negative effects, such as lumpy, gel-like structures (gelling). Without being bound by theory, it is posited that the disclosed particle sizes have a reduced strength in particle-particle contact network relative to dispersive shear forces in typical laundering processes; better dispersion of disclosed particles reduces the probability of enduring contacts, forming a lumpy, gel-like structure.

### Definitions

Features and benefits of the present disclosure will become apparent from the following description, which includes examples intended to give a broad representation of the invention. Various modifications will be apparent to those skilled in the art from this description and from practice of the invention. The scope is not intended to be limited to the particular forms disclosed and the invention covers all modifications, equivalents, and alternatives falling within the spirit and scope of the invention as defined by the claims.

As used herein, the articles including “the,” “a” and “an” when used in a claim or in the specification, are understood to mean one or more of what is claimed or described.

As used herein, the terms “include,” “includes” and “including” are meant to be non-limiting.

The term “substantially free of” or “substantially free from” as used herein refers to either the complete absence of an ingredient or a minimal amount thereof merely as impurity or unintended byproduct of another ingredient. A composition that is “substantially free” of/from a component means that the composition comprises less than about 0.5%, 0.25%, 0.1%, 0.05%, or 0.01%, or even 0%, by weight of the composition, of the component.

In this description, all concentrations and ratios are on a weight basis of the composition unless otherwise specified.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Water-Soluble Unit Dose Article

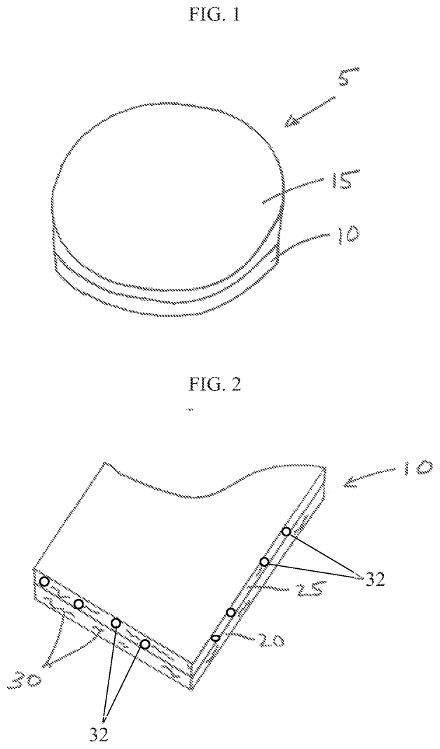

Water-soluble unit dose articles comprising a water-soluble fibrous structure and a plurality of particles associated with the water-soluble fibrous structure are disclosed herein. A water-soluble unit dose article 5 is shown in FIG. 1. The water-soluble unit dose article 5 may comprise a water-soluble first ply 10 and a water-soluble second ply 15 that are superposed relative to one another. A portion of the first ply 10 may be joined to a portion of the second ply 15 to form the water-soluble unit dose article 5. Joining of the plies is further described hereinafter.

As used herein, the phrases “water-soluble unit dose article,” “water-soluble fibrous element,” “water-soluble fibrous structure,” and “water-soluble particle” means that the unit dose article, fibrous element, fibrous structure or particle is soluble or dispersible in water, and preferably has a water-solubility of at least 50%, preferably at least 75% or even at least 95%, as measured by the method set out hereafter using a glass-filter with a maximum pore size of 20 microns: 50 grams±0.1 gram of the unit dose article, fibrous elements, fibrous structure, and/or particles is added in a pre-weighed 400 mL beaker and 245 mL±1 mL of distilled water is added. This is stirred vigorously on a magnetic stirrer set at 600 rpm, for 30 minutes. Then, the mixture is filtered through a sintered-glass filter with a pore size as defined above (max. 20 micron). The steps are performed at ambient conditions. “Ambient conditions” as used herein means 23° C.±1.0° C. and a relative humidity of 50%±2%. The water is dried off from the collected filtrate by any conventional method, and the weight of the remaining material is determined (which is the dissolved or dispersed fraction). Then, the percentage solubility or dispersability can be calculated.

These water-soluble unit dose articles can be dissolved under various wash conditions, e.g., low temperature, low water and/or short wash cycles or cycles where consumers have been overloading the machine, especially with items with high water absorption capacity, while providing delivery of active agents for the intended effect on the target consumer substrates (with similar performance as today's liquid products). Furthermore, the water-soluble unit dose articles described herein can be produced in an economical manner by spinning fibers comprising active agents. The water-soluble unit dose articles described herein also have improved cleaning performance.

General Characteristics

The surface of the water-soluble unit dose article may comprise a printed area. The printed area may cover between about 10% and about 100% of the surface of the water-soluble unit dose article. The area of print may comprise inks, pigments, dyes, bluing agents, or mixtures thereof. The area of print may be opaque, translucent, or transparent. The area of print may comprise a single color or multiple colors. The printed area maybe on more than one side of the water-soluble unit dose article and contain instructional text and/or graphics. The surface of the water-soluble unit dose article may comprise an aversive agent, for example a bittering agent. Suitable bittering agents include, but are not limited to, naringin, sucrose octacetate, quinine hydrochloride, denatonium benzoate, or mixtures thereof. Any suitable level of aversive agent may be used. Suitable levels include, but are not limited to, from about 1 to about 5000 ppm, or even from about 100 to about 2500 ppm, or even from about 250 to about 2000 ppm.

The water-soluble unit dose article may have a basis weight of from about 500 grams/m² to about 10,000 grams/m², or from about 1,000 grams/m² to about 8,000 grams/m², or from about 2000 grams/m² to about 6,000 grams/m², or from about 3,000 grams/m² to about 5,000 grams/m², as measured according to the Basis Weight Test Method described herein.

“Width,” as used herein with respect to dimensions of an article, may refer to the measurement according to its conventional definition. For a rectilinear-shaped article, for example, the width refers to the distance from one edge to an opposite edge. However, with respect to articles of irregular shape, the width refers to the maximum feret or caliper diameter, which is the longest distance between two parallel planes tangential to the boundary of the article. In one example, an average width can be provided by measuring ten substantially similar replicate articles, compiling an average of the ten individual article width measurements, and reporting the value to the nearest 0.01 cm, where the individual article width measurements can be taken by any appropriate instrument that is calibrated, NIST traceable, and capable of a measurement to the nearest 0.01 cm.

“Length,” as used herein with respect to dimensions of an article, may refer to a measurement according to its conventional definition. For example, with respect to articles of irregular shape, the length refers to the maximum feret or caliper diameter, which is the longest distance between two parallel planes tangential to the boundary of the article. For a rectilinear-shaped article, for example, the length refers to the distance from one edge to an opposite edge. In one example, an average length can be provided by measuring ten substantially similar replicate articles, compiling an average of the ten individual article length measurements, and reporting the value to the nearest 0.01 cm, where the individual article length measurements can be taken by any appropriate instrument that is calibrated, NIST traceable, and capable of a measurement to the nearest 0.01 cm.

“Height,” as used herein with respect to dimensions of an article, may refer to the measurement according to its conventional definition. The height, or thickness, of an article, for example, can be measured by the Thickness Test Method described herein.

The water-soluble unit dose article may have a length of from about 1 cm to about 20 cm; from about 2 cm to about 20 cm; from about 2 cm to about 18 cm; from about 3 cm to about 15 cm; from about 3 cm to about 12 cm; from about 4 cm to about 8 cm; from about 4 cm to about 6 cm; or from about 5 cm to about 6 cm. In certain examples, the water-soluble unit dose article may have a length of from about 1 cm to about 10 cm; from about 2 cm to about 10 cm; or from about 7 cm to about 9 cm.

The water-soluble unit dose article can have a width of from about 1 cm to about 11 cm; from about 2 cm to about 11 cm; from about 2 cm to about 10 cm; from about 3 cm to about 9 cm; from about 4 cm to about 8 cm; or from about 4 cm to about 6 cm. In certain examples, the article can have a width of from about 1 cm to about 6 cm; from about 2 cm to about 6 cm; from about 3 cm to about 5 cm; or from about 3.5 cm to about 4.5 cm. In other examples, the water-soluble unit dose article can have a width of from about 6 cm to about 8 cm.

The ratio of a length of the water-soluble unit dose article to its width can be from about 3:1 to about 0.5:1; from about 5:2 to about 0.5:1; or from about 2:1 to about 1:1.

The water-soluble unit dose articles may exhibit a height, or thickness, of greater than about 0.01 mm and/or greater than about 0.05 mm and/or greater than about 0.1 mm and/or to about 100 mm and/or to about 50 mm and/or to about 20 mm and/or to about 10 mm and/or to about 5 mm and/or to about 2 mm and/or to about 0.5 mm and/or to about 0.3 mm as measured by the Thickness Test Method described herein.

It is believed that article dimensions (e.g., width, length, height) can contribute to achieving a product-shipping assembly that can provide desirable packaging properties, such as minimized packaging sizes, reduced shipping costs, and a maximized ratio of an article volume to a packaging volume, while still providing protection for the water-soluble unit dose articles. For example, it is believed that providing desirable article dimensions can facilitate reduction of damage, thereby reducing costs and waste; improve efficiency in shipping by, for example, providing a shipping container that can fit in a mail slot; and ensure immobilization and protection of the articles by, for example, minimizing the space in which article can move within the shipping container.

The water-soluble unit dose article may exhibit different regions, such as different regions of basis weight, density, caliper, and/or wetting characteristics. The water-soluble unit dose article may comprise texture on one or more of its surfaces. A surface of the water-soluble unit dose article may comprise a pattern, such as a non-random, repeating pattern. The water-soluble unit dose article may comprise apertures. The water-soluble unit dose article may comprise a fibrous structure having discrete regions of fibrous elements that differ from other regions of fibrous elements in the structure. The water-soluble unit dose article may comprise a fibrous structure having discrete regions of one or more particles that differ from other regions of the fibrous structure in the structure. The water-soluble unit dose article may be used as is or it may be additionally coated with one or more active agents.

Fibrous Structure

The water-soluble unit dose article can be viewed hierarchically starting from the form in which the consumer interacts with, the water-soluble unit dose article, and working backward to the raw materials from which the water-soluble unit dose article is made, e.g., plies, layers, fibrous structures, fibrous elements, and particles. The fibrous plies may be fibrous structures. Fibrous structures may comprise one or more fibrous elements. The fibrous elements may be associated with one another to form a fibrous structure. Fibrous structures may include particles within and or on the fibrous structure. The fibrous structure may be water-soluble. Upon addition of the water-soluble unit dose article to water, the water-soluble unit dose article may dissolve and release the particles into the wash liquor.

A fibrous structure may be comprised of a single ply or multiple plies. The fibrous structure may be comprised of at least two and/or at least three and/or at least four and/or at least five plies. Each ply may comprise one or more fibrous layers. Fibrous layers may comprise fibrous elements and particles, forming a particle-fiber composite layer. Fibrous layers may comprise fibrous elements and be void of particles. FIG. 2 shows a non-limiting example of a ply. FIG. 2 shows a non-limiting example of a first ply 10 having a first fibrous layer 20 and a second fibrous layer 25. In the non-limiting example shown in FIG. 2, the first fibrous layer 20 comprises fibrous elements 30 and is void of particles 32, and the second fibrous layer 25 comprises both fibrous elements 30 and particles 32, forming a particle-fiber composite layer. Any number of fibrous layers within a ply may comprise fibrous elements and be void of particles. Any number of fibrous layers within a ply may comprise both fibrous elements and particles, forming particle-fiber composite layers.

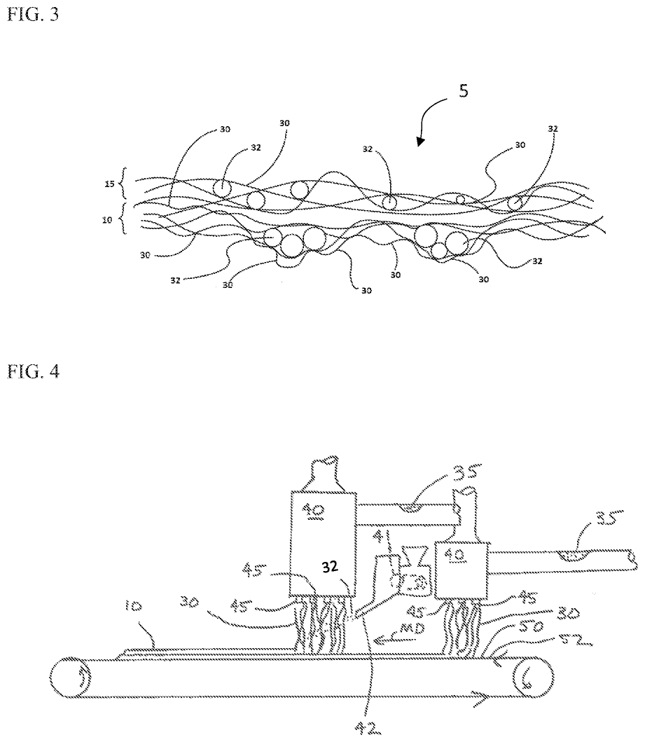

The first ply 10 and second ply 15 may be associated to form a water-soluble unit dose article 5. For example, FIG. 3 shows a water-soluble unit dose article 5 comprising a first ply 10 and a second ply 15 associated with the first ply 10, wherein the first ply 10 and the second ply 15 each comprise a plurality of fibrous elements 30, and a plurality of particles 32. In the second ply 15, the particles 32 are dispersed randomly in the x, y, and z axes. In the first ply 10, the particles 32 are in pockets left between the fibrous elements 30 forming the non-woven structure of the fibrous structure. Alternatively, the plurality of particles 32 may be laid on top of the fibrous structure. The second ply 15 may be separate from the first ply 10. The first ply 10 and the second ply 15 may be superposed. Methods of making plies are described hereinafter.

The fibrous structure may comprise a plurality of fibrous elements that are inter-entangled or otherwise associated with one another to form the fibrous structure. A plurality of particles may be associated with the fibrous structure. “Associate,” “associated,” “association” and/or “associating” as used herein with respect to fibrous elements and/or particles means combining, either in direct contact or in indirect contact, fibrous elements and/or particles such that a fibrous structure is formed. Fibrous structures can be homogeneous, layered, unitary, zoned, or as otherwise desired, with different active agents defining the various aforesaid portions.

The water-soluble unit dose article may comprise a water-soluble fibrous structure and two or more identical or substantially identical, from a compositional perspective, particles associated with the fibrous structure. The water-soluble unit dose article may comprise a water-soluble fibrous structure and two or more different particles. Non-limiting examples of differences in the particles may be physical differences, such as differences in diameter, length, texture, shape, rigidness, elasticity, and the like; chemical differences, such as crosslinking level, solubility, melting point, glass transition temperature (Tg), active agent, color, level of active agent, presence of any coating on the particle, biodegradable or not, hydrophobic or not, and the like; differences in whether the particle loses its physical structure when the particle is exposed to conditions of intended use; differences in whether the particle's morphology changes when the particle is exposed to conditions of intended use; and differences in rate at which the particle releases one or more of its active agents when the particle is exposed to conditions of intended use. Two or more particles within the unit dose article may comprise different active agents. This may be the case where the different active agents may be incompatible with one another, for example an anionic surfactant and a cationic polymer. When using different particles, the resulting structure may exhibit different wetting, imbibitions, and solubility characteristics.

The water-soluble fibrous structure may comprise a plurality of identical or substantially identical, from a compositional perspective, fibrous elements. The water-soluble fibrous structure may comprise two or more different fibrous elements. Non-limiting examples of differences in the fibrous elements may be physical differences, such as differences in diameter, length, texture, shape, rigidness, elasticity, and the like; chemical differences, such as crosslinking level, solubility, melting point, glass transition temperature (Tg), active agent, filament-forming material, color, level of active agent, basis weight, level of filament-forming material, presence of any coating on fibrous element, biodegradable or not, hydrophobic or not, contact angle, and the like; differences in whether the fibrous element loses its physical structure when the fibrous element is exposed to conditions of intended use; differences in whether the fibrous element's morphology changes when the fibrous element is exposed to conditions of intended use; and differences in rate at which the fibrous element releases one or more of its active agents when the fibrous element is exposed to conditions of intended use. Two or more fibrous elements within the fibrous structure may comprise different active agents. This may be the case where the different active agents may be incompatible with one another, for example, an anionic surfactant and a cationic polymer. When using different fibrous elements, the resulting structure may exhibit different wetting, imbibitions, and solubility characteristics.

The fibrous elements and/or the plurality of particles may be arranged within the water-soluble unit dose article in a single ply or in multiple plies, to provide the water-soluble unit dose article with two or more regions that comprise different active agents. For example, one region of the water-soluble unit dose article may comprise bleaching agents and/or surfactants and another region of the water-soluble unit dose article may comprise softening agents. This is particularly beneficial when there are two or more active agents that are incompatible and direct interaction with one another would cause a lowering of effectiveness. The particles and fibrous elements are described in more detail below.

### Particles

The water-soluble unit dose article disclosed herein may comprise a plurality of particles associated with the water-soluble fibrous structure. One or more of the particles may be water-soluble. One or more of the particles may comprise a water-insoluble material, wherein the water-insoluble material is dispersible in aqueous wash conditions to a suspension mean particle size that is less than about 50 microns, or less than about 20 microns.

The particle may be discrete. As used herein, the term “discrete” refers to particles that are structurally distinctive from each other either under naked human eyes or under electronic imaging devices, such as scanning electron microscope (SEM) and transmission electron microscope (TEM). The particles may be discrete from each other under naked human eyes.

As used herein, the term “particle” refers to a solid matter of minute quantity. The particle may be a powder, granule, agglomerate, encapsulate, microcapsule, and/or prill. The particle may be made using a number of well-known methods in the art, such as spray-drying, agglomeration, extrusion, prilling, encapsulation, pastillation and combinations thereof. The shape of the particle can be in the form of spheres, rods, plates, tubes, squares, rectangles, discs, stars, or flakes of regular or irregular shapes. The particles disclosed herein are generally non-fibrous.

The plurality of particles may have a particle size distribution such that the D50 particle size is from about 1 mm to about 4.75 mm preferably, the plurality of particles may have a particle size distribution such that the D50 particle size is from about 1.7 mm to about 3.5 mm. In a non-limiting example, the plurality of particles may have a particle size distribution such that the D20 particle size is greater than about 1 mm and the D80 particle size is less than about 4.75 mm. In a non-limiting example, the plurality of particles may have a particle size distribution such that the D20 particle size is greater than about 1.7 mm and the D80 particle size is less than about 3.5 mm. In a non-limiting example, the plurality of particles may have a particle size distribution such that the D10 particle size is greater than about 1 mm and the D80 particle size is less than about 4.75 mm. In a non-limiting example, the plurality of particles may have a particle size distribution such that the D10 particle size is greater than about 1.7 mm and the D80 particle size is less than about 3.5 mm. The particle size distribution is measured according to the Granular Size Distribution Test Method described herein. Surprisingly, it has been found that particles of the disclosed size distributions may allow for effective dissolution and dispersion of the unit dose article in the wash without gelling while still providing a satisfactory consumer experience with regards to satisfactory cleaning, as the particles comprise sufficient levels of active agents to provide a level of cleaning regarded as satisfactory, and are of a distance from one another sufficient to preclude direct interaction of incompatible active agents.

A benefit of incorporating particles of the disclosed size distribution may relate to consumers' perceived value of the product, such as a unit dose article for use in laundering fabric. For example, the inclusion of larger-sized particles as part of the water-soluble unit dose article may provide strong cues to the consumer demonstrating the presence of a beneficial ingredient, even if present only in very small amounts. Further, some particles that are larger in size may be heavier in weight. It is known that a product's size and weight may affect a consumer's perceived value of a product. A larger and heavier in weight product may indicate a higher value perception to consumers as compared to a smaller and lesser in weight product. Further, larger-sized particles may be more readily visible to the naked eye. Visible particles within the product might lead consumers to perceive that there are more ingredients present within the product because they can actually see what they believe to be the ingredients rather than when the ingredients are solely incorporated within a web or within a liquid composition and are difficult to see. Consumers might perceive that the larger and heavier in weight product having visible particles may be providing higher levels of beneficial ingredients and perhaps better benefit of the product. This is especially true with regards to cleaning products, such as laundry detergent products, as consumers often have a preconceived expectation that using more units of the product may provide superior cleaning whereas using fewer units of the product may provide inferior cleaning, and that detergents where they cannot see the ingredients might be lacking ingredients.

The plurality of particles may comprise a relatively low water (moisture) content (e.g., no more than about 10%, by weight of the particle, of water, or no more than about 8%, by weight of the particle, of water, or no more than about 5%, by weight of the particle, of water, especially a relatively low free/unbound water content (e.g., no more than about 3%, by weight of the particle, of free or unbound water, or no more than about 1%, by weight of the particle, of free or unbound water), so that water from the particles will not compromise the structural integrity of the fibrous structure. Further, a controlled moisture content in the particles reduces the risk of gelling in the particles themselves. The water (moisture) content present in a particle is measured according to the Water Content Test Method as described herein.

The bulk density of the plurality of particles may range from about 400 g/L to about 1000 g/L, or from about 500 g/L to about 900 g/L, or from about 600 g/L to about 800 g/L.

One or more of the particles may comprise one or more active agents (e.g., adjunct detergent ingredients) for assisting or enhancing cleaning performance and/or to modify the aesthetics thereof. One or more of the particles may releasably comprise an active agent, such as when the particles comprising the active agents are exposed to conditions of intended use. One or more of the particles may comprise from about 3% to about 95%, from about 5% to about 85%, from about 10% to about 75%, from about 15% to about 65%, by weight of the particle, of an active agent. The active agent may be selected from the group consisting of a surfactant, a structurant, a builder, organic polymeric compounds, a polymeric dispersing agent, an enzyme, an enzyme stabilizer, a bleach system, a brightener, a hueing agent, a chelating agent, a suds suppressor, a suds booster, a dye transfer inhibiting agent, a conditioning agent, a perfume, an encapsulate comprising a perfume, a buffer, an alkanolamine, and mixtures thereof. A bleach system may comprise one or more bleach activators, bleach catalysts, bleaches, and any other components known to one skilled in the art relating to bleach within particles for use in laundry detergent compositions.

In a non-limiting example, one or more of the particles may comprise an active agent, wherein the active agent may comprise a bleach system, wherein the bleach system may comprise a bleach activator selected from the group consisting of nonanoyloxybenzene sulfonate (NOBS), tetraacetylethylenediamine (TAED), acyl hydrazine, amido-derived bleach activators, and mixtures thereof, preferably the bleach activator is nonanoyloxybenzene sulfonate (NOBS). Amido-derived bleach activators may include but are not limited to (6-octanamidocaproyl)oxybenzenesulfonate, (6-25 nonanamidocaproyl)oxybenzenesulfonate, and (6-decanamidocaproyl)oxybenzenesulfonate. Bleach systems are further described hereinafter.

In a non-limiting example, one or more of the particles may comprise an active agent, wherein the active agent may comprise a surfactant. The surfactant may be selected from the group consisting of anionic surfactants, cationic surfactants, nonionic surfactants, zwitterionic surfactants, amphoteric surfactants, and mixtures thereof. Surfactants are further described hereinafter.

In a non-limiting example, one or more of the particles may comprise an active agent, wherein the active agent may comprise a polymeric dispersing agent. The polymeric dispersing agent may be an alkoxylated polyethyleneimine (PEI). Polymeric dispersing agents are further described hereinafter.

In a non-limiting example, one or more of the particles may comprise an active agent, wherein the active agent may comprise an enzyme. Enzymes are further described hereinafter.

Active agents are further described hereinafter.

The particles may be the same or different. The particles may be solid, free-flowing particles. The particles may comprise a fully formulated laundry detergent composition or a portion thereof, such as a spray-dried, extruded or agglomerate particle that forms part of a laundry detergent composition. The water-soluble unit dose article disclosed herein may comprise a plurality of chemically different particles, such as spray-dried base detergent particles and/or agglomerated base detergent particles and/or extruded base detergent particles, in combination with one or more, typically two or more, or five or more, or even ten or more particles selected from: surfactant particles, including surfactant agglomerates, surfactant extrudates, surfactant needles, surfactant noodles, surfactant flakes; phosphate particles; zeolite particles; silicate salt particles, especially sodium silicate particles; carbonate salt particles, especially sodium carbonate particles; polymer particles such as carboxylate polymer particles, cellulosic polymer particles, starch particles, polyester particles, polyamine particles, terephthalate polymer particles, polyethylene glycol particles; aesthetic particles such as coloured noodles, needles, lamellae particles and ring particles; enzyme particles such as protease granulates, amylase granulates, lipase granulates, cellulase granulates, mannanase granulates, pectate lyase granulates, xyloglucanase granulates, bleaching enzyme granulates and co-granulates of any of these enzymes, preferably these enzyme granulates comprise sodium sulphate; bleach particles, such as percarbonate particles, especially coated percarbonate particles, such as percarbonate coated with carbonate salt, sulphate salt, silicate salt, borosilicate salt, or any combination thereof, perborate particles, bleach activator particles such as tetraacetylethylenediamine particles and/or alkyl oxybenzene sulfonate particles, bleach catalyst particles such as transition metal catalyst particles, and/or isoquinolinium bleach catalyst particles, pre-formed peracid particles, especially coated pre-formed peracid particles; filler particles such as sulphate salt particles and chloride particles; clay particles such as montmorillonite particles and particles of clay and silicone; flocculant particles such as polyethylene oxide particles; wax particles such as wax agglomerates; silicone particles, brightener particles; dye transfer inhibition particles; dye fixative particles; perfume particles such as perfume microcapsules and starch encapsulated perfume accord particles, or pro-perfume particles such as Schiff base reaction product particles; hueing dye particles; chelant particles such as chelant agglomerates; and any combination thereof.

Alkyl Alkoxy Sulfate-Containing Particles

At least about 10%, or at least about 20%, or at least about 30%, or at least about 40%, or at least about 50%, or at least about 60%, or at least about 70%, or at least about 80%, or at least about 90%, and up to about 100% of the particles in each water-soluble unit dose article may comprise an alkyl alkoxy sulfate surfactant (e.g., alkyl ethoxy sulfate or AES). Surprisingly, it has been found that by segregating from about 10% to about 100% of the total alkyl alkoxy sulfate surfactant present in each water-soluble unit dose article to the one or more particles, rather than the fibrous elements of the structure, a better dissolving and better cleaning water-soluble unit dose articles may be made.

An alkyl ethoxy sulfate-containing particle (referred to herein as an AES particle) may comprise from about 5 mass % to about 60 mass % ethoxylated alkyl sulfate surfactant having a molar average degree of ethoxylation from about 0.5 to about 6. Optionally, the particle may comprise adjunct active components including co-surfactant, buffer, builder, detersive polymer, and/or chelant actives. Optionally, the particle may comprise structurant materials used to stabilize the surfactant in a solid phase. The ethoxylated alkyl sulfate surfactant may have a molar average degree of ethoxylation of from about 0.8 to about 1.2 and a molar ethoxylation distribution such that: (i) from about 40 wt % to about 50 wt % has a degree of ethoxylation of 0 (in other words, unethoxylated); (ii) from about 20 mass % to about 30 mass % has a degree of ethoxylation of 1; (iii) from about 20 mass % to about 40 mass % has a degree of ethoxylation of 2 or greater. The molar ethoxylation distribution of AES may be manipulated by controlling the molar ethoxylation distribution of the ethoxylated alcohol product during its synthesis. The molar ethoxylation distribution of the AES may be determined by measuring the molecular weight distribution via mass spectrometry. Ethoxylated alkyl sulfate surfactant may be synthesized using methods that are well known in the art.

The AES particle may be in the form of an agglomerate made by agglomerating a concentrated surfactant paste with adjunct powder materials. The AES particle may comprise additional cleaning actives, such as hygroscopic actives that are effective in cold-water detergency and/or actives that are difficult to process and/or stabilize physically in a solid form.

The AES particle may comprise from about 10 wt % to about 80 wt % builder. The builder may be selected from the group consisting of zeolite-A, layered silicate, carboxymethyl cellulose, and mixtures thereof. The AES particle may comprise powder process aids suitable for stabilizing its physical and chemical structure. Suitable powder process aids include precipitated silica and variants thereof. The AES particle may comprise from about 10 wt % to about 40 wt % of a buffering agent. The buffering agent may be selected from the group consisting of sodium carbonate, sodium bicarbonate, sodium silicate, sodium bisulfate, sodium sesquisulfate, citric acid, and mixtures thereof. The AES particle may comprise from about 5 wt % to about 20 wt % chelant. The chelant may be selected from the group consisting of sodium citrate, tetrasodium carboxylatomethyl-glutamate (commercially available from AkzoNobel, Amsterdam, Netherlands, under the tradename DISSOLVINE® or GLDA), trisodium methylglycinediacetate (commercially available from BASF USA, Cincinnati, Ohio, USA, under the tradename TRILON® M or MGDA), diethylene triamine pentaacetic acid (DTPA), ethylenediamine tetraacetic acid (EDTA), ethylenediamine disuccininate (EDDS), disodium dihydroxy benzenedisulfonate, and mixtures thereof.

The AES particle may comprise from about 5 to 20 wt % of a polymeric dispersing agent selected from the group consisting of polyethyleneimine (ethoxylated and alkoxylated), alkali polycarboxylate and variants thereof, preferably sodium polycarboxylate, amphilic graft co-polymers, e.g., those commercially available from BASF USA (Cincinnati, Ohio, USA) under the tradename SOKALAN® HP22, modified polyacrylates, and mixtures thereof. Polymeric dispersing agents are further described hereinafter.

The AES particle may comprise from about 1 to 15 wt % fiber-structuring polymer selected from the group consisting of polyvinyl alcohol (PVOH), polyethylene oxide (PEO), and blends thereof, the polyvinyl alcohol (PVOH) having a degree of hydrolysis from about 75% to 85%, and a weight average molecular weight from about 30,000 to 80,000 g/mole, and the polyethylene oxide (PEO) having a weight average molecular weight from about 100,000 to 2,000,000 g/mole.

Other Particles

The water-soluble unit dose article may further comprise a plurality of smaller-sized particles associated with the water-soluble fibrous structure. Such smaller-sized particles may be beneficial in providing active agents that are present in the unit dose article in lower levels. The plurality of smaller-sized particles may be dispersed randomly in the x, y, and z axes of the fibrous structure. The plurality of smaller-sized particles may be in pockets left between fibrous elements forming the non-woven structure of the fibrous structure. The plurality of smaller-sized particles may be laid on top of the fibrous structure. “Smaller-sized particles” refers to a plurality of particles having a particle size distribution such that the D50 particle size is from about 0.001 mm to about 0.9 mm, as measured according to the Granular Size Distribution Test Method. The plurality of smaller-sized particles may have a particle size distribution such that the D50 particle size is from about 0.05 mm to about 0.75 mm, as measured according to the Granular Size Distribution Test Method. In a non-limiting example, the water-soluble unit dose article may comprise a water-soluble fibrous structure and a plurality of particles associated with the water-soluble fibrous structure, wherein the plurality of particles may have a particle distribution size such that the D50 particle size is from about 1 mm to about 4.75 mm, and a plurality of smaller-sized particles associated with the water-soluble fibrous structure, wherein the plurality of smaller-sized particles may have a particle size distribution such that the D50 particle size is from about 0.001 mm to about 0.9 mm, as measured according to the Granular Size Distribution Test Method. The unit dose article may comprise any quantity of smaller-sized particles suitable to provide the intended benefit of the unit dose article. One or more of the smaller-sized particles may comprise an active agent. One or more of the smaller-sized particles may releasably comprise an active agent. One or more of the smaller-sized particles may comprise from about 3% to about 95%, by weight of the particle, of an active agent.

### Fibrous Elements

In general, fibrous elements are elongated particulates having a length greatly exceeding average diameter, e.g., a length to average diameter ratio of at least about 10. A fibrous element may be a filament or a fiber. Filaments are relatively longer than fibers. A filament may have a length of greater than or equal to about 5.08 cm (2 in.), and/or greater than or equal to about 7.62 cm (3 in.), and/or greater than or equal to about 10.16 cm (4 in.), and/or greater than or equal to about 15.24 cm (6 in.). A fiber may have a length of less than about 5.08 cm (2 in.), and/or less than about 3.81 cm (1.5 in.), and/or less than about 2.54 cm (1 in.). “Length” as used herein with respect to a fibrous element, means the length along the longest axis of the fibrous element from one terminus to the other terminus. If a fibrous element has a kink, curl or curves in it, then the length is the length along the entire path of the fibrous element from one terminus to the other terminus.

The fibrous elements may be water-soluble. The fibrous elements may comprise one or more filament-forming materials. The fibrous elements of the present disclosure may be spun from a filament-forming composition, also referred to as fibrous element-forming compositions, via suitable spinning process operations, such as meltblowing, spunbonding, electro-spinning, and/or rotary spinning. “Filament-forming composition” and/or “fibrous element-forming composition” as used herein means a composition that is suitable for making a fibrous element of the present disclosure such as by meltblowing and/or spunbonding. The filament-forming composition comprises one or more filament-forming materials that exhibit properties that make them suitable for spinning into a fibrous element. The filament-forming material may comprise a polymer. In addition to one or more filament-forming materials, the filament-forming composition may comprise one or more active agents, for example, a surfactant. In addition, the filament-forming composition may comprise one or more polar solvents, such as water, into which one or more, for example all, of the filament-forming materials and/or one or more, for example all, of the active agents are dissolved and/or dispersed prior to spinning a fibrous element, such as a filament from the filament-forming composition.

The filament-forming composition may comprise two or more different filament-forming materials. Thus, the fibrous elements may be monocomponent (one type of filament-forming material) and/or multicomponent, such as bicomponent. The two or more different filament-forming materials may be randomly combined to form a fibrous element. The two or more different filament-forming materials may be orderly combined to form a fibrous element, such as a core and sheath bicomponent fibrous element, which is not considered a random mixture of different filament-forming materials for purposes of the present disclosure. Bicomponent fibrous elements may be in any form, such as side-by-side, core and sheath, islands-in-the-sea and the like.

One or more of the fibrous elements may comprise from about 5% to about 80%, by weight on a dry fibrous element basis, of a filament-forming material. One or more of the fibrous elements may comprise at least about 5%, and/or at least about 10%, and/or at least about 15%, and/or at least about 20%, and/or less than about 80%, and/or less than about 75%, and/or less than about 65%, and/or less than about 60%, and/or less than about 55%, and/or less than about 50%, and/or less than about 45%, and/or less than about 40%, and/or less than about 35%, and/or less than about 30%, and/or less than about 25%, by weight on a dry fibrous element basis, of a filament-forming material.

The filament-forming material may be a material, such as a polymer or monomers capable of producing a polymer, that exhibits properties suitable for making a fibrous element, such as by spinning process. In an example, the filament-forming material may comprise a polar solvent-soluble material, such as an alcohol-soluble material and/or a water-soluble material. In an example, the filament-forming material may comprise a non-polar solvent-soluble material. In an example, the filament-forming material may be a film-forming material. In an example, the filament-forming material may be synthetic or of natural origin and it may be chemically enzymatically, and/or physically modified.

In an example, the filament-forming material may comprise a polymer selected from the group consisting of: polymers derived from acrylic monomers such as the ethylenically unsaturated carboxylic monomers and ethylenically unsaturated monomers, polyvinyl alcohol, polyvinylformamide, polyvinylamine, polyacrylates, polymethacrylates, copolymers of acrylic acid and methyl acrylate, polyvinylpyrrolidones, polyalkylene oxides, starch and starch derivatives, pullulan, gelatin, and cellulose derivatives (for example, hydroxypropylmethyl celluloses, methyl celluloses, carboxymethyl celluloses).

In an example, the filament-forming material may comprises a polymer selected from the group consisting of: polyvinyl alcohol (PVOH), polyvinyl alcohol (PVOH) derivatives, starch, starch derivatives, cellulose derivatives, hemicellulose, hemicellulose derivatives, proteins, sodium alginate, hydroxypropyl methylcellulose, chitosan, chitosan derivatives, polyethylene glycol, tetramethylene ether glycol, polyvinyl pyrrolidone, hydroxymethyl cellulose, hydroxyethyl cellulose, carboxymethyl cellulose, and mixtures thereof.

In an example, the filament-forming material comprises one or more substituted polymers such as an anionic, cationic, zwitterionic, and/or nonionic polymer. The polymer may comprise a hydroxyl polymer, such as polyvinyl alcohol (PVOH), a partially hydrolyzed polyvinyl acetate, and/or a polysaccharide, such as starch and/or a starch derivative, such as an ethoxylated starch and/or an acid-thinned starch, carboxymethylcellulose, hydroxypropyl cellulose, and/or hydroxyethyl cellulose. The polymer may comprise polyethylenes and/or terephthalates. The filament-forming material may be selected from the group consisting of pullulan, hydroxypropylmethyl cellulose, hydroxyethyl cellulose, hydroxypropyl cellulose, polyvinyl pyrrolidone, sodium alginate, xanthan gum, tragacanth gum, guar gum, acacia gum, Arabic gum, polyacrylic acid, methylmethacrylate copolymer, carboxyvinyl polymer, dextrin, pectin, chitin, levan, elsinan, collagen, gelatin, zein, gluten, soy protein, casein, polyvinyl alcohol (PVOH), carboxylated polyvinyl alcohol (PVOH), sulfonated polyvinyl alcohol (PVOH), starch, starch derivatives, hemicellulose, hemicellulose derivatives, proteins, chitosan, chitosan derivatives, polyethylene glycol, tetramethylene ether glycol, hydroxymethyl cellulose, carboxymethylcellulose, polyethylene oxide (PEO), hydroxyl-containing polymers and their derivatives, and mixtures thereof. Preferably, Preferably, the filament-forming material may be selected from the group consisting of polyvinyl alcohol (PVOH), starch, carboxymethylcellulose, polyethylene oxide (PEO), hydroxyl-containing polymers and their derivatives, and mixtures thereof. One or more of the fibrous elements may comprise a filament-forming material selected from the group consisting of polyvinyl alcohol (PVOH), starch, carboxymethylcellulose, polyethylene oxide (PEO), hydroxyl-containing polymers and their derivatives, and mixtures thereof. The filament-forming material may comprise other such suitable polymers known to one skilled in the art. The filament-forming material may range in weight average molecular weight from about 100,000 g/mol to about 3,000,000 g/mol. It is believed that in this range, the filament-forming material may provide extensional rheology, without being so elastic that fiber attenuation is inhibited in the fiber-making process.

One or more of the fibrous elements may comprise an active agent. One or more of the fibrous elements may releasably comprise an active agent, such as when the one or more fibrous elements comprising the active agents are exposed to conditions of intended use. One or more of the fibrous elements may comprise from about 5% to about 95%, by weight on a dry fibrous element basis, of an active agent. One or more of the fibrous elements may comprise from about 10% to about 90%, by weight on a dry fibrous element basis, of an active agent. One or more of the fibrous elements may comprise greater than about 20%, and/or at least about 35%, and/or at least about 40%, and/or at least about 45%, and/or at least about 50%, and/or at least about 55%, and/or at least about 60%, and/or at least about 65%, and/or at least about 70%, and/or less than about 95%, and/or less than about 90%, and/or less than about 85%, and/or less than about 80%, and/or less than about 75%, by weight on a dry fibrous element basis, of an active agent.

The active agent may be selected from the group consisting of a surfactant, a structurant, a builder, organic polymeric compounds, a polymeric dispersing agent, an enzyme, an enzyme stabilizer, a bleach system, a brightener, a hueing agent, a chelating agent, a suds suppressor, a suds booster, a dye transfer inhibiting agent, a conditioning agent, a perfume, an encapsulate comprising a perfume, a buffer, an alkanolamine, and mixtures thereof. The surfactant may be selected from the group consisting of anionic surfactants, alkoxylated amines, and mixtures thereof. The active agent may be selected from the group consisting of alkyl alkoxy sulfates (e.g., alkyl ethoxy sulfate or AES), alkoxylated polyamines, and mixtures thereof. Active agents are further described in greater detail below.

One or more fibrous elements may comprise two or more different active agents, which are compatible or incompatible with one another. One or more fibrous elements may comprise an active agent within the fibrous element and an active agent on an external surface of the fibrous element, such as an active agent coating on the fibrous element. The active agent on the external surface of the fibrous element may be the same or different from the active agent present in the fibrous element. If different, the active agents may be compatible or incompatible with one another. The active agents may be uniformly distributed or substantially uniformly distributed throughout a fibrous element. The active agents may be distributed as discrete regions within a fibrous element.

In a non-limiting example, one or more of the fibrous elements may comprise from about 10% to less than about 80%, by weight on a dry fibrous element basis of a filament-forming material, such as polyvinyl alcohol polymer, starch polymer, and/or carboxymethylcellulose polymer, and greater than from about 20% to less than about 90%, by weight on a dry fibrous element basis, of an active agent. The fibrous elements may further comprise a plasticizer, such as glycerin, and/or pH adjusting agents, such as citric acid. The fibrous elements may have a weight ratio of filament-forming material to active agent of about 2.0 or less. The filament-forming materials and active agents may be present in the fibrous element at a weight ratio of total level of filament-forming materials to active agents of about 2.0 or less, and/or about 1.85 or less, and/or less than about 1.7, and/or less than about 1.6, and/or less than about 1.5, and/or less than about 1.3, and/or less than about 1.2, and/or less than about 1, and/or less than about 0.7, and/or less than about 0.5, and/or less than about 0.4, and/or less than about 0.3, and/or greater than about 0.1, and/or greater than about 0.15, and/or greater than about 0.2. The filament-forming material and active agents may be present in the fibrous element at a weight ratio of total level of filament-forming materials to active agents of about 0.2 to about 0.7.

The fibrous elements of the present disclosure may be hydrophilic or hydrophobic. The fibrous elements may be surface treated and/or internally treated to change the inherent hydrophilic or hydrophobic properties of the fibrous element.

The fibrous elements may exhibit a diameter of less than about 300 μm, and/or less than about 75 μm, and/or less than about 50 μm, and/or less than about 25 μm, and/or less than about 10 μm, and/or less than about 5 μm, and/or less than about 1 μm as measured according to the Diameter Test Method described herein. The fibrous elements may exhibit a diameter of greater than about 1 μm as measured according to the Diameter Test Method described herein. The diameter of a fibrous element may be used to control the rate of release of one or more active agents present in the fibrous element and/or the rate of loss and/or altering of the fibrous element's physical structure.

### Active Agents

The water-soluble unit dose articles described herein may comprise one or more active agents. The active agents may be present in the fibrous elements (as described above), in the particles (as described above), and/or as a premix in the water-soluble unit dose article. Premixes for example, may be slurries of active agents that are combined with aqueous absorbents. The active agent may be selected from the group consisting of a surfactant, a structurant, a builder, an organic polymeric compound, a polymeric dispersing agent, an enzyme, an enzyme stabilizer, a bleach system, a brightener, a hueing agent, a chelating agent, a suds suppressor, a conditioning agent, a humectant, a perfume, an encapsulate comprising a perfume, a filler or carrier, an alkalinity system, a pH control system, a buffer, an alkanolamine, and mixtures thereof. This list is non-limiting and other such active agents conventionally found within laundry detergents and household care compositions may be included.

Surfactant

The surfactant may be selected from the group consisting of anionic surfactants, nonionic surfactants, cationic surfactants, zwitterionic surfactants, amphoteric surfactants, ampholytic surfactants, and mixtures thereof. In non-limiting examples, compositions of the present disclosure, including filament-forming compositions and particle compositions, may comprise from about 10% to about 80%, or from about 20% to about 70%, by weight of the composition, of surfactant.

Anionic Surfactant

Suitable anionic surfactants may exist in an acid form, and the acid form may be neutralized to form a surfactant salt. Typical agents for neutralization include metal counterion bases, such as hydroxides, e.g., NaOH or KOH. Further suitable agents for neutralizing anionic surfactants in their acid forms include ammonia, amines, or alkanolamines. Non-limiting examples of alkanolamines include monoethanolamine, diethanolamine, triethanolamine, and other linear or branched alkanolamines known in the art; suitable alkanolamines include 2-amino-1-propanol, 1-aminopropanol, monoisopropanolamine, or 1-amino-3-propanol. Amine neutralization may be done to a full or partial extent, e.g., part of the anionic surfactant mix may be neutralized with sodium or potassium and part of the anionic surfactant mix may be neutralized with amines or alkanolamines.

Anionic surfactants may be supplemented with salt as a means to regulate phase behavior; suitable salts may be selected from the group consisting of sodium sulfate, magnesium sulfate, sodium carbonate, sodium citrate, sodium silicate, and mixtures thereof.

Non-limiting examples of suitable anionic surfactants include any conventional anionic surfactant. This may include a sulfate detersive surfactant, for e.g., alkoxylated and/or non-alkoxylated alkyl sulfate materials, and/or sulfonic detersive surfactants, e.g., alkyl benzene sulfonates. Suitable anionic surfactants may be derived from renewable resources, waste, petroleum, or mixtures thereof. Suitable anionic surfactants may be linear, partially branched, branched, or mixtures thereof.

Alkoxylated alkyl sulfate materials may comprise ethoxylated alkyl sulfate surfactants, also known as alkyl ether sulfates or alkyl polyethoxylate sulfates. Examples of ethoxylated alkyl sulfates include water-soluble salts, particularly the alkali metal, ammonium and alkylolammonium salts, of organic sulfuric reaction products having in their molecular structure an alkyl group containing from about 8 to about 30 carbon atoms and a sulfonic acid and its salts. Included in the term “alkyl” is the alkyl portion of acyl groups. In some examples, the alkyl group contains from about 15 carbon atoms to about 30 carbon atoms. In other examples, the alkyl ether sulfate surfactant may be a mixture of alkyl ether sulfates, the mixture having an average (arithmetic mean) carbon chain length within the range of about 12 to 30 carbon atoms, and in some examples an average carbon chain length of about 12 to 15 carbon atoms, and an average (arithmetic mean) degree of ethoxylation of from about 1 mol to 4 moles of ethylene oxide, and in some examples an average (arithmetic mean) degree of ethoxylation of 1.8 moles of ethylene oxide. In further examples, the alkyl ether sulfate surfactant may have a carbon chain length between about 10 carbon atoms to about 18 carbon atoms, and a degree of ethoxylation of from about 1 to about 6 moles of ethylene oxide. In yet further examples, the alkyl ether sulfate surfactant may contain a peaked ethoxylate distribution.

Non-alkoxylated alkyl sulfates may be used as an anionic surfactant component. Examples of non-alkoxylated, e.g., non-ethoxylated, alkyl sulfate surfactants include those produced by the sulfation of higher C₈-C₂₀ fatty alcohols. In some examples, primary alkyl sulfate surfactants have the general formula: ROSO₃⁻M⁺, wherein R is typically a linear C₈-C₂₀ hydrocarbyl group, which may be straight chain or branched chain, and M is a water-solubilizing cation. In some examples, R is a C₁₀-C₁₈ alkyl, and M is an alkali metal. In other examples, R is a C₁₂/C₁₄ alkyl and M is sodium, such as those derived from natural alcohols.

Other useful anionic surfactants can include the alkali metal salts of alkyl benzene sulfonates, in which the alkyl group contains from about 9 to about 15 carbon atoms, in straight chain (linear) or branched chain configuration. In some examples, the alkyl group is linear. Such linear alkylbenzene sulfonates are known as “LAS.” In other examples, the linear alkylbenzene sulfonate may have an average number of carbon atoms in the alkyl group of from about 11 to 14. In a specific example, the linear straight chain alkyl benzene sulfonates may have an average number of carbon atoms in the alkyl group of about 11.8 carbon atoms, which may be abbreviated as C11.8 LAS.

Suitable alkyl benzene sulfonate (LAS) may be obtained, by sulfonating commercially available linear alkyl benzene (LAB); suitable LAB includes low 2-phenyl LAB, including those commercially available from Sasol Limited (Sandton, South Africa) under the tradename ISOCHEM® or those commercially available by Petroquímica Española S.A., Petresa, (Madrid, Spain) under the tradename PETRELAB®, other suitable LAB include high 2-phenyl LAB, including those commercially available from Sasol Limited (Sandton, South Africa) under the tradename HYBLENE®. A suitable anionic detersive surfactant is alkyl benzene sulfonate that is obtained by the DETAL catalyzed process, although other synthesis routes, such as HF, may also be suitable. In one aspect, a magnesium salt of LAS is used.

Another example of a suitable alkyl benzene sulfonate is a modified LAS (MLAS), which is a positional isomer that contains a branch, e.g., a methyl branch, where the aromatic ring is attached to the 2 or the 3 position of the alkyl chain.

The anionic surfactant may include a 2-alkyl branched primary alkyl sulfates have 100% branching at the C2 position (C1 is the carbon atom covalently attached to the alkoxylated sulfate moiety). 2-alkyl branched alkyl sulfates and 2-alkyl branched alkyl alkoxy sulfates are generally derived from 2-alkyl branched alcohols (as hydrophobes). 2-alkyl branched alcohols, e.g., 2-alkyl-1-alkanols or 2-alkyl primary alcohols, which are derived from the oxo process, including those commercially available from Sasol Limited (Sandton, South Africa) under the tradename LIAL® and ISALCHEM® (which is prepared from LIAL® alcohols by a fractionation process). C14/C15 branched primary alkyl sulfate is also commercially available from Sasol Limited (Sandton, South Africa) under the tradename LIAL® 145 sulfate.

The anionic surfactant may include a mid-chain branched anionic surfactant, e.g., a mid-chain branched anionic detersive surfactant, such as, a mid-chain branched alkyl sulphate and/or a mid-chain branched alkyl benzene sulfonate.

Additional suitable anionic surfactants include methyl ester sulfonates, paraffin sulfonates, α-olefin sulfonates, and internal olefin sulfonates.

Nonionic Surfactant

Suitable nonionic surfactants include alkoxylated fatty alcohols. The nonionic surfactant may be selected from ethoxylated alcohols and ethoxylated alkyl phenols of the formula R(OC₂H₄)ₙOH, wherein R is selected from the group consisting of aliphatic hydrocarbon radicals containing from about 8 to about 15 carbon atoms and alkyl phenyl radicals in which the alkyl groups contain from about 8 to about 12 carbon atoms, and the average value of n is from about 5 to about 15.

Other non-limiting examples of nonionic surfactants useful herein include: C₈-C₁₈ alkyl ethoxylates, including those commercially available from Shell Chemicals (Houston, Tex.) under the tradename NEODOL®; C₆-C₁₂ alkyl phenol alkoxylates where the alkoxylate units may be ethyleneoxy units, propyleneoxy units, or a mixture thereof; C₁₂-C₁₈ alcohol and C₆-C₁₂ alkyl phenol condensates with ethylene oxide/propylene oxide block polymers such as those commercially available from BASF USA (Cincinnati, Ohio, USA) under the tradename PLURONIC®; C₁₄-C₂₂ mid-chain branched alcohols, BA; C₁₄-C₂₂ mid-chain branched alkyl alkoxylates, BAEₓ, wherein x is from 1 to 30; alkylpolysaccharides; specifically alkylpolyglycosides; polyhydroxy fatty acid amides; and ether capped poly(oxyalkylated) alcohol surfactants.

Suitable nonionic detersive surfactants also include alkyl polyglucoside and alkyl alkoxylated alcohol. Suitable nonionic surfactants also include those commercially available from BASF USA (Cincinnati, Ohio, USA) under the tradename LUTENSOL®.

Cationic Surfactant

Non-limiting examples of cationic surfactants include: the quaternary ammonium surfactants, which can have up to 26 carbon atoms include: alkoxylate quaternary ammonium (AQA) surfactants; dimethyl hydroxyethyl quaternary ammonium; dimethyl hydroxyethyl lauryl ammonium chloride; polyamine cationic surfactants; cationic ester surfactants; and amino surfactants, e.g., amido propyldimethyl amine (APA).

Suitable cationic detersive surfactants also include alkyl pyridinium compounds, alkyl quaternary ammonium compounds, alkyl quaternary phosphonium compounds, alkyl ternary sulfonium compounds, and mixtures thereof.

Suitable cationic detersive surfactants are quaternary ammonium compounds having the general formula:

(R)(R₁)(R₂)(R₃)N⁺X⁻

wherein, R is a linear or branched, substituted or unsubstituted C₆₋₁₈ alkyl or alkenyl moiety; R₁ and R₂ are independently selected from methyl or ethyl moieties; R₃ is a hydroxyl, hydroxymethyl or a hydroxyethyl moiety; and X is an anion which provides charge neutrality, suitable anions include: halides, for example chloride; sulphate; and sulfonate. Suitable cationic detersive surfactants are mono-C₆₋₁₈ alkyl mono-hydroxyethyl di-methyl quaternary ammonium chlorides. Highly suitable cationic detersive surfactants are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride.

Zwitterionic Surfactant

Suitable zwitterionic surfactants include: derivatives of secondary and tertiary amines, derivatives of heterocyclic secondary and tertiary amines, and derivatives of quaternary ammonium, quaternary phosphonium or tertiary sulfonium compounds. Suitable examples of zwitterionic surfactants include betaines, including alkyl dimethyl betaine and cocodimethyl amidopropyl betaine, C₈ to C₁₈ (for example from C₁₂ to C₁₈) amine oxides, and sulfo and hydroxy betaines, such as N-alkyl-N,N-dimethylamino-1-propane sulfonate where the alkyl group can be C₈ to C₁₈.

Amphoteric Surfactant

Suitable amphoteric surfactants include aliphatic derivatives of secondary or tertiary amines, or aliphatic derivatives of heterocyclic secondary and tertiary amines in which the aliphatic radical may be straight or branched-chain and where one of the aliphatic substituents contains at least about 8 carbon atoms, or from about 8 to about 18 carbon atoms, and at least one of the aliphatic substituents contains an anionic water-solubilizing group, e.g., carboxy, sulfonate, sulfate. Suitable amphoteric surfactants also include sarcosinates, glycinates, taurinates, and mixtures thereof.

Enzymes

Examples of suitable enzymes include, but are not limited to, hemicellulases, peroxidases, proteases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, ß-glucanases, arabinosidases, hyaluronidase, chondroitinase, laccase, and amylases, or mixtures thereof. A typical combination is an enzyme cocktail that may comprise, for example, a protease and lipase in conjunction with amylase. The aforementioned additional enzymes may be present at levels from about 0.00001% to about 2%, from about 0.0001% to about 1% or even from about 0.001% to about 0.5% enzyme protein, by weight of the composition. The compositions, filament-forming compositions and particles compositions, disclosed herein may comprise from about 0.001% to about 1%, by weight of an enzyme (as an adjunct), which may be selected from the group consisting of lipase, amylase, protease, mannanase, cellulase, pectinase, and mixtures thereof.

Builders

Suitable builders include aluminosilicates (e.g., zeolite builders, such as zeolite A, zeolite P, and zeolite MAP), silicates, phosphates, such as polyphosphates (e.g., sodium tri-polyphosphate), especially sodium salts thereof; carbonates, bicarbonates, sesquicarbonates, and carbonate minerals other than sodium carbonate or sesquicarbonate; organic mono-, di-, tri-, and tetracarboxylates, especially water-soluble nonsurfactant carboxylates in acid, sodium, potassium or alkanolammonium salt form, as well as oligomeric or water-soluble low weight average molecular weight polymer carboxylates including aliphatic and aromatic types; and phytic acid. Additional suitable builders may be selected from citric acid, lactic acid, fatty acid, polycarboxylate builders, for example, copolymers of acrylic acid, copolymers of acrylic acid and maleic acid, and copolymers of acrylic acid and/or maleic acid, and other suitable ethylenic monomers with various types of additional functionalities. Alternatively, the compositions, filament-forming compositions and particle compositions, may be substantially free of builder.

Polymeric Dispersing Agents

Suitable polymeric dispersing agents include carboxymethylcellulose, poly(vinylpyrrolidone), poly (ethylene glycol), an ethylene oxide-propylene oxide-ethylene oxide (EOx₁POyEOx₂) triblock copolymer, where each of x₁ and x₂ is in the range of about 2 to about 140 and y is in the range of from about 15 to about 70, poly(vinyl alcohol), poly(vinylpyridine-N-oxide), poly(vinylimidazole), polycarboxylates such as polyacrylates, maleic/acrylic acid copolymers and lauryl methacrylate/acrylic acid co-polymers.

Suitable polymeric dispersing agents include amphiphilic cleaning polymers such as the compound having the following general structure: bis((C₂H₅O)(C₂H₄O)n)(CH₃)—N⁺—CₓH₂ₓ—⁺—(CH₃)-bis((C₂H₅O)(C₂H₄O)n), wherein n=from 20 to 30, and x=from 3 to 8, or sulphated or sulfonated variants thereof.

Suitable polymeric dispersing agents include amphiphilic alkoxylated grease cleaning polymers which have balanced hydrophilic and hydrophobic properties such that they remove grease particles from fabrics and surfaces. The amphiphilic alkoxylated grease cleaning polymers may comprise a core structure and a plurality of alkoxylate groups attached to that core structure. These may comprise alkoxylated polyalkylenimines having an inner polyethylene oxide block and an outer polypropylene oxide block. Such compounds may include, but are not limited to, ethoxylated polyethyleneimine, ethoxylated hexamethylene diamine, and sulfated versions thereof. Polypropoxylated derivatives may also be included. A wide variety of amines and polyalklyeneimines can be alkoxylated to various degrees. A useful example is 600 g/mol polyethyleneimine core ethoxylated to 20 EO groups per NH. The compositions, filament-forming compositions and particle compositions, described herein may comprise from about 0.1% to about 20%, and in some examples, from about 0.1% to about 10%, and in other examples, from about 0.1% to about 8%, by weight of the composition, of alkoxylated polyamines.

Suitable polymeric dispersing agents include carboxylate polymer. Suitable carboxylate polymers, which may optionally be sulfonated, include a maleate/acrylate random copolymer or a poly(meth)acrylate homopolymer. In one aspect, the carboxylate polymer is a poly(meth)acrylate homopolymer having a weight average molecular weight from 4,000 Da to 9,000 Da, or from 6,000 Da to 9,000 Da.

Suitable polymeric dispersing agents include alkoxylated polycarboxylates, which may also be used to provide grease removal. Chemically, these materials comprise poly(meth)acrylates having one ethoxy side-chain per every 7-8 (meth)acrylate units. The side-chains are of the formula —(CH₂CH₂O)ₘ(CH₂)ₙCH₃ wherein m is 2-3 and n is 6-12. The side-chains are ester-linked to the polyacrylate “backbone” to provide a “comb” polymer type structure. The weight average molecular weight can vary, but may be in the range of about 2000 to about 50,000. The compositions, filament-forming compositions and particle compositions, described herein may comprise from about 0.1% to about 10%, and in some examples, from about 0.25% to about 5%, and in other examples, from about 0.3% to about 2%, by weight of the composition, of alkoxylated polycarboxylates.

Suitable polymeric dispersing agents include amphiphilic graft co-polymers. A suitable amphiphilic graft co-polymer comprises (i) a polyethylene glycol backbone; and (ii) and at least one pendant moiety selected from polyvinyl acetate, polyvinyl alcohol (PVOH) and mixtures thereof. A suitable amphilic graft co-polymer includes those made commercially available from BASF USA (Cincinnati, Ohio, USA) under the tradename SOKALAN® HP22. Suitable polymers include random graft copolymers, for example, a polyvinyl acetate grafted polyethylene oxide copolymer having a polyethylene oxide backbone and multiple polyvinyl acetate side chains. The weight average molecular weight of the polyethylene oxide backbone is typically about 6000 and the weight ratio of the polyethylene oxide to polyvinyl acetate is about 40 to 60 and no more than 1 grafting point per 50 ethylene oxide units.

Soil Release Polymer

Suitable soil release polymers may have a structure as defined by one of the following structures (I), (II) or (III):

—[(OCHR¹—CHR²)ₐ—O—OC—Ar—CO—]_{d} (I)

—[(OCHR³—CHR⁴)_{b}—O—OC-sAr—CO—]ₑ (II)

—[(OCHR⁵—CHR⁶)_{c}—OR⁷]_{f} (III)

wherein:

a, b and c are from 1 to 200;

d, e and f are from 1 to 50;

Ar is a 1,4-substituted phenylene;

sAr is 1,3-substituted phenylene substituted in position 5 with SO₃Me;

Me is Li, K, Mg/2, Ca/2, Al/3, ammonium, mono-, di-, tri-, or tetraalkylammonium wherein the alkyl groups are C₁-C₁₈ alkyl or C₂-C₁₀ hydroxyalkyl, or mixtures thereof;

R¹, R², R³, R⁴, R⁵ and R⁶ are independently selected from H or C₁-C₁₈ n- or iso-alkyl; and

R⁷ is a linear or branched C₁-C₁₈ alkyl, or a linear or branched C₂-C₃₀ alkenyl, or a cycloalkyl group with 5 to 9 carbon atoms, or a C₈-C₃₀ aryl group, or a C₆-C₃₀ arylalkyl group.

Suitable soil release polymers are polyester soil release polymers such as those commercially available from Rhodia (acquired by the Solvay Group, La Defense, France) under the tradename REPEL-O-TEX®, including REPEL-O-TEX® SF, REPEL-O-TEX® SF-2, and REPEL-O-TEX® SRP6. Other suitable soil release polymers include those commercially available from Clariant (Charlotte, N.C., USA) under the tradename TEXCARE®, including TEXCARE® SRA100, TEXCARE® SRA300, TEXCARE® SRN100, TEXCARE® SRN170, TEXCARE® SRN240, TEXCARE® SRN300, and TEXCARE® SRN325. Other suitable soil release polymers include those commercially available from Sasol Limited (Sandton, South Africa) under the tradename MARLOQUEST® SL.

Cellulosic Polymer

Suitable cellulosic polymers including those selected from alkyl cellulose, alkyl alkoxy alkyl cellulose, carboxyalkyl cellulose, alkyl carboxyalkyl cellulose. The cellulosic polymers may be selected from the group consisting of carboxymethyl cellulose, methyl cellulose, methyl hydroxyethyl cellulose, methyl carboxymethyl cellulose, and mixtures thereof. In one aspect, the carboxymethyl cellulose may have a degree of carboxymethyl substitution from 0.5 to 0.9 and a weight average molecular weight from 100,000 Da to 300,000 Da.

Amines

Non-limiting examples of amines may include, but are not limited to, polyetheramines, polyamines, oligoamines, triamines, diamines, pentamines, tetraamines, or combinations thereof. Specific examples of suitable additional amines include tetraethylenepentamine, triethylenetetraamine, diethylenetriamine, or a mixture thereof.

Bleach Systems

A bleach system may comprise one or more bleach activators, bleach catalysts, bleaches, and any other components known to one skilled in the art relating to bleach within particles for use in laundry detergent compositions. Other components may include photobleaches, hydrogen peroxide, sources of hydrogen peroxide, pre-formed peracids and mixtures thereof. Suitable bleach catalysts include, but are not limited to: iminium cations and polyions; iminium zwitterions; modified amines; modified amine oxides; N-sulfonyl imines; N-phosphonyl imines; N-acyl imines; thiadiazole dioxides; perfluoroimines; cyclic sugar ketones and mixtures thereof. Suitable bleach activators include, but are not limited to: nonanoyloxybenzene sulfonate (NOBS), tetraacetylethylenediamine (TAED), acyl hydrazine, amido-derived bleach activators, and mixtures thereof. Amido-derived bleach activators may include but are not limited to (6-octanamidocaproyl)oxybenzenesulfonate, (6-25 nonanamidocaproyl)oxybenzenesulfonate, and (6-decanamidocaproyl)oxybenzenesulfonate.

Brighteners

Commercial fluorescent brighteners suitable for the present disclosure can be classified into subgroups, including but not limited to: derivatives of stilbene, pyrazoline, coumarin, benzoxazoles, carboxylic acid, methinecyanines, dibenzothiophene-5,5-dioxide, azoles, 5- and 6-membered-ring heterocycles, and other miscellaneous agents.

The fluorescent brightener may be selected from the group consisting of disodium 4,4′-bis{[4-anilino-6-morpholino-s-triazin-2-yl]-amino}-2,2′-stilbenedisulfonate; disodium4,4′-bis{[4-anilino-6-(N-2-bis-hydroxyethyl)-s-triazine-2-yl]-amino}-2,2′-stilbenedisulonate; disodium 4,4′-bis{[4-anilino-6-(N-2-hydroxyethyl-N-methylamino)-s-triazine-2-yl]-amino}-2,2′-stilbenedisulfonate; and mixtures thereof.

4,4′-bis{[4-anilino-6-morpholino-s-triazin-2-yl]-amino}-2,2′-stilbenedisulfonate may include that which is commercially available from BASF USA (Cincinnati, Ohio, USA) under the tradename TINOPAL® AMS-GX, brightener 15. Disodium4,4′-bis{[4-anilino-6-(N-2-bis-hydroxyethyl)-s-triazine-2-yl]-amino}-2,2′-stilbenedisulonate may include that which is commercially available from BASF USA (Cincinnati, Ohio, USA) under the tradename Tinopal® UNPA-GX). Disodium 4,4′-bis{[4-anilino-6-(N-2-hydroxyethyl-N-methylamino)-s-triazine-2-yl]-amino}-2,2′-stilbenedisulfonate may include that which is commercially available from BASF USA (Cincinnati, Ohio, USA) under the tradename Tinopal® 5BM-GX). The fluorescent brightener may be disodium 4,4′-bis{[4-anilino-6-morpholino-s-triazin-2-yl]-amino}-2,2′-stilbenedisulfonate.

The brighteners may be added in particulate form or as a premix with a suitable solvent, for example nonionic surfactant, propanediol.

Fabric Hueing Agents

A fabric hueing agent (sometimes referred to as shading, bluing or whitening agents) typically provides a blue or violet shade to fabric. Hueing agents can be used either alone or in combination to create a specific shade of hueing and/or to shade different fabric types. This may be provided for example by mixing a red and green-blue dye to yield a blue or violet shade. Hueing agents may be selected from any known chemical class of dye, including but not limited to acridine, anthraquinone (including polycyclic quinones), azine, azo (e.g., monoazo, disazo, trisazo, tetrakisazo, polyazo), including premetallized azo, benzodifurane and benzodifuranone, carotenoid, coumarin, cyanine, diazahemicyanine, diphenylmethane, formazan, hemicyanine, indigoids, methane, naphthalimides, naphthoquinone, nitro and nitroso, oxazine, phthalocyanine, pyrazoles, stilbene, styryl, triarylmethane, triphenylmethane, xanthenes and mixtures thereof.

Suitable fabric hueing agents include dyes, dye-clay conjugates, and organic and inorganic pigments. Suitable dyes also include small molecule dyes and polymeric dyes. Suitable small molecule dyes include small molecule dyes selected from the group consisting of dyes falling into the Color Index (C.I.) classifications of Direct, Basic, Reactive or hydrolyzed Reactive, Solvent or Disperse dyes for example that are classified as Blue, Violet, Red, Green or Black, and provide the desired shade either alone or in combination. Suitable polymeric dyes include polymeric dyes selected from the group consisting of polymers containing covalently bound (sometimes referred to as conjugated) chromogens, (dye-polymer conjugates), for example polymers with chromogens co-polymerized into the backbone of the polymer and mixtures thereof. Suitable polymeric dyes also include polymeric dyes selected from the group consisting of fabric-substantive colorants commercially available from Milliken (Spartanburg, S.C., USA) under the tradename f LIQUITINT®, dye-polymer conjugates formed from at least one reactive dye and a polymer selected from the group consisting of polymers comprising a moiety selected from the group consisting of a hydroxyl moiety, a primary amine moiety, a secondary amine moiety, a thiol moiety and mixtures thereof. Suitable polymeric dyes also include polymeric dyes selected from the group consisting of non-staining colorants; carboxymethyl cellulose (CMC) covalently bound to a reactive blue, reactive violet or reactive red dye; alkoxylated triphenyl-methane polymeric colorants; alkoxylated thiophene polymeric colorants; and mixtures thereof.

A non-limiting example of a non-staining colorant is that which is commercially available from Milliken Chemical (Spartanburg, S.C., USA) under the tradename LIQUITINT® Violet CT. A non-limiting example of a carboxymethyl cellulose (CMC) covalently bound to a reactive blue is that which is commercially available by Megazyme (Wicklow, Ireland) under the product name Azo-CM-Cellulose, product code S-ACMC.

The aforementioned fabric hueing agents can be used in combination (any mixture of fabric hueing agents can be used).

Encapsulates

An encapsulate may comprise a core, a shell having an inner and outer surface, the shell encapsulating the core. The core may comprise any laundry care adjunct, though typically the core may comprise a laundry care adjunct selected from the group consisting of perfumes; brighteners; hueing dyes; insect repellants; silicones; waxes; flavors; fabric softening agents; skin care agents in one aspect, paraffins; enzymes; anti-bacterial agents; bleaches; sensates; and mixtures thereof. The shell may comprise a laundry care adjunct selected from the group consisting of polyethylenes; polyamides; polyvinyl alcohols, optionally containing other co-monomers; polystyrenes; polyisoprenes; polycarbonates; polyesters; polyacrylates; aminoplasts, in one aspect the aminoplast may comprise a polyureas, polyurethane, and/or polyureaurethane, in one aspect the polyurea may comprise polyoxymethylene urea and/or melamine formaldehyde; polyolefins; polysaccharides, in one aspect the polysaccharide may comprise alginate and/or chitosan; gelatin; shellac; epoxy resins; vinyl polymers; water insoluble inorganics; silicone; and mixtures thereof.

Preferred encapsulates may comprise perfume, such as a perfume microcapsule. Preferred encapsulates may comprise a shell which may comprise melamine formaldehyde and/or cross-linked melamine formaldehyde. Other preferred capsules may comprise a polyacrylate based shell. Preferred encapsulates may comprise a core material and a shell, the shell at least partially surrounding the core material, is disclosed. At least 75%, 85% or even 90% of the encapsulates may have a fracture strength of from 0.2 MPa to 10 MPa, and a benefit agent leakage of from 0% to 20%, or even less than 10% or 5% based on total initial encapsulated benefit agent. Preferred are those in which at least 75%, 85% or even 90% of the encapsulates may have (i) a particle size of from 1 microns to 80 microns, 5 microns to 60 microns, from 10 microns to 50 microns, or even from 15 microns to 40 microns, and/or (ii) at least 75%, 85% or even 90% of said encapsulates may have a particle wall thickness of from 30 nm to 250 nm, from 80 nm to 180 nm, or even from 100 nm to 160 nm. Formaldehyde scavengers may be employed with the encapsulates, for example, in a capsule slurry and/or added to a composition before, during or after the encapsulates are added to such composition.

Suitable capsules that can be made using known processes. Alternatively, suitable capsules can be purchased from Encapsys LLC (Appleton, Wis., USA). The water-soluble unit dose article may further comprise a deposition aid, for example, in addition to encapsulates. Preferred deposition aids are selected from the group consisting of cationic and nonionic polymers. Suitable polymers include cationic starches, cationic hydroxyethyl cellulose, polyvinyl-formaldehyde, locust bean gum, mannans, xyloglucans, tamarind gum, polyethylene terephthalate and polymers containing dimethylaminoethyl methacrylate, optionally with one or more monomers selected from the group comprising acrylic acid and acrylamide.

Perfumes

Non-limiting examples of perfume and perfumery ingredients include, but are not limited to, aldehydes, ketones, esters, and the like. Other examples include various natural extracts and essences which can comprise complex mixtures of ingredients, such as orange oil, lemon oil, rose extract, lavender, musk, patchouli, balsamic essence, sandalwood oil, pine oil, cedar, and the like. Finished perfumes can comprise extremely complex mixtures of such ingredients. Finished perfumes may be included at a concentration ranging from about 0.01% to about 2%, by weight of the composition.

Dye Transfer Inhibiting Agents

Dye transfer inhibiting agents are effective for inhibiting the transfer of dyes from one fabric to another during the cleaning process. Generally, such dye transfer inhibiting agents may include polyvinyl pyrrolidone polymers, polyamine N-oxide polymers, copolymers of N-vinylpyrrolidone and N-vinylimidazole, manganese phthalocyanine, peroxidases, and mixtures thereof. If used, these agents may be used at a concentration of about 0.0001% to about 10%, by weight of the composition, in some examples, from about 0.01% to about 5%, by weight of the composition, and in other examples, from about 0.05% to about 2%, by weight of the composition.

Chelating Agents

Suitable chelating agents include copper, iron and/or manganese chelating agents and mixtures thereof. Such chelating agents can be selected from the group consisting of phosphonates, amino carboxylates, amino phosphonates, succinates, polyfunctionally-substituted aromatic chelating agents, 2-pyridinol-N-oxide compounds, hydroxamic acids, carboxymethyl inulins and mixtures thereof. Chelating agents can be present in the acid or salt form including alkali metal, ammonium, and substituted ammonium salts thereof, and mixtures thereof. Other suitable chelating agents for use herein are those made commercially available from Dequest Italmatch Chemicals (Genoa, Italy) under the tradename DEQUEST® series; those made commercially available from BASF USA (Cincinnati, Ohio, USA) under the tradename TRILON® series; and further chelants made commercially available from Akzo-Nobel N.V. (Amsterdam, Netherlands), DowDuPont, formerly DuPont and Dow Chemical, (Midland, Mich., USA and Wilmington, Del., USA), and Nalco (Naperville, Ill., USA).

Suds Suppressors

Compounds for reducing or suppressing the formation of suds can be incorporated into the water-soluble unit dose articles. Suds suppression can be of particular importance in the so-called “high concentration cleaning process” and in front-loading style washing machines. Examples of suds suppressors include monocarboxylic fatty acid and soluble salts therein, high molecular weight hydrocarbons such as paraffin, fatty acid esters (e.g., fatty acid triglycerides), fatty acid esters of monovalent alcohols, aliphatic C₁₈-C₄₀ ketones (e.g., stearone), N-alkylated amino triazines, waxy hydrocarbons having a melting point below about 100° C., silicone suds suppressors, and secondary alcohols.

Additional suitable antifoams are those derived from phenylpropyl methyl substituted polysiloxanes.

The compositions, filament-forming compositions and particle compositions, may comprise a suds suppressor selected from organomodified silicone polymers with aryl or alkyl aryl substituents combined with silicone resin and a primary filler, which is modified silica. The compositions may comprise from about 0.001% to about 4.0%, by weight of the composition, of such a suds suppressor.

The composition may comprise a suds suppressor selected from: a) mixtures of from about 80 to about 92% ethylmethyl, methyl(2-phenylpropyl) siloxane; from about 5 to about 14% MQ resin in octyl stearate; and from about 3 to about 7% modified silica; b) mixtures of from about 78 to about 92% ethylmethyl, methyl(2-phenylpropyl) siloxane; from about 3 to about 10% MQ resin in octyl stearate; from about 4 to about 12% modified silica; or c) mixtures thereof, where the percentages are by weight of the anti-foam.

Suds Boosters

If high sudsing is desired, suds boosters such as the C₁₀-C₁₆ alkanolamides may be used. Some examples include the C₁₀-C₁₄ monoethanol and diethanol amides. If desired, water-soluble magnesium and/or calcium salts such as MgCl₂, MgSO₄, CaCl₂), CaSO₄, and the like, may be added at levels of about 0.1% to about 2%, by weight of the composition, to provide additional suds and to enhance grease removal performance.

Conditioning Agents

Suitable conditioning agents include high melting point fatty compounds. The high melting point fatty compound useful herein has a melting point of 25° C. or higher, and is selected from the group consisting of fatty alcohols, fatty acids, fatty alcohol derivatives, fatty acid derivatives, and mixtures thereof. Suitable conditioning agents also include nonionic polymers and conditioning oils, such as hydrocarbon oils, polyolefins, and fatty esters.

Suitable conditioning agents include those conditioning agents characterized generally as silicones (e.g., silicone oils, polyoils, cationic silicones, silicone gums, high refractive silicones, and silicone resins), organic conditioning oils (e.g., hydrocarbon oils, polyolefins, and fatty esters) or combinations thereof, or those conditioning agents which otherwise form liquid, dispersed particles in the aqueous surfactant matrix herein.

Fabric Enhancement Polymers

Suitable fabric enhancement polymers are typically cationically charged and/or have a high weight average molecular weight. The fabric enhancement polymers may be a homopolymer or be formed from two or more types of monomers. The monomer weight of the polymer will generally be between 5,000 and 10,000,000, typically at least 10,000, and preferably in the range 100,000 to 2,000,000. Preferred fabric enhancement polymers will have cationic charge densities of at least 0.2 meq/gm, preferably at least 0.25 meq/gm, more preferably at least 0.3 meq/gm, but also preferably less than 5 meq/gm, more preferably less than 3 meq/gm, and most preferably less than 2 meq/gm at the pH of intended use of the composition, wherein pH will generally range from pH 3 to pH 9, preferably between pH 4 and pH 8. The fabric enhancement polymers may be of natural or synthetic origin.

Pearlescent Agent

Non-limiting examples of pearlescent agents include: mica; titanium dioxide coated mica; bismuth oxychloride; fish scales; mono and diesters of alkylene glycol. The pearlescent agent may be ethylene glycol distearate (EGDS).

Hygiene and Malodor

Suitable hygiene and malodor active agents include zinc ricinoleate, thymol, quaternary ammonium salts including those commercially available from Lonza (Basel Switzerland) under the tradename BARDAC™, polyethylenimines and zinc complexes thereof including those commercially available from BASF USA (Cincinnati, Ohio, USA) under the tradename LUPASOL®, silver and silver compounds, especially those designed to slowly release Ag⁺ or nano-silver dispersions.

Buffer System

The water-soluble unit dose articles described herein may be formulated such that, during use in aqueous washing or cleaning operations, the wash water will have a pH of between about 7 and about 12, and in some examples, between about 7 and about 11. Techniques for controlling pH at recommended usage levels include the use of buffers, alkalis, or acids, and are well known to those skilled in the art. These include, but are not limited to, the use of sodium carbonate, citric acid or sodium citrate, lactic acid or lactate, monoethanol amine or other amines, boric acid or borates, and other pH-adjusting compounds well known in the art.

The compositions herein may comprise dynamic in-wash pH profiles. Such compositions may use wax-covered citric acid particles in conjunction with other pH control agents such that (i) about 3 minutes after contact with water, the pH of the wash liquor is greater than 10; (ii) about 10 minutes after contact with water, the pH of the wash liquor is less than 9.5; (iii) about 20 minutes after contact with water, the pH of the wash liquor is less than 9.0; and (iv) optionally, wherein, the equilibrium pH of the wash liquor is in the range of from about 7.0 to about 8.5.

### Method of Making a Particle

Particles having the disclosed size distribution may be made by a number of methods. Preferred processes include granulation by extrusion/cutting, extrusion/spheronization, agglomeration, spray-drying, layering, and combinations thereof.

Extrusion-granulation is preferably done with a stiff paste comprising surfactant actives through a forming die, making noodles of a desired cross-section, typically cylindrical with a characteristic diameter. The noodles may be cut or broken into sections, and optionally rounded using tumbling mixer or spheronizer. In cases where the extruded surface is sticky, a fine dry powder acting as flow-aid may be added in the mixing or spheronization step, said fine powder effectively coating the extruded section.

Binder agglomeration may be used to form granules, combining a suitable liquid binder and fine powder in a mixer having suitable flow and stress fields to produce granules. Preferred binders may include detergent actives such as liquid surfactants, surfactant solutions, detersive polymer solutions, and chelant solutions. Preferred powders may include builders, buffers and other dried detergent ingredients. If additional powder is needed for processing, fine-absorbent powders such as precipitated silica of clay may be used as an inert process aid.

The size of any core granule, for example made by extrusion, agglomeration or spray-drying, may be increased using a layering process. Suitable layering processes are described in detail in U.S. Publication 2007/0196502.

### Method of Making a Water-Soluble Unit Dose Article

The present disclosure also encompasses a method of making a water-soluble unit dose article, the method comprising the steps of: a) providing a water-soluble first ply; b) providing a water-soluble second ply, wherein the water-soluble second ply is separate from the water-soluble first ply; c) providing a plurality of particles; d) associating the plurality of particles with the water-soluble first ply and/or the water-soluble second ply; e) superposing the water-soluble first ply and the water-soluble second ply; and f) joining a portion of the water-soluble first ply to a portion of the water-soluble second ply to form the water-soluble unit dose article, wherein the plurality of particles is contained within the water-soluble unit dose article, wherein the plurality of particles has a particle size distribution such that the D50 particle size is from about 1 mm to about 4.75 mm, as measured according to the Granular Size Distribution Test Method. By contained within, it is meant that the particles do not readily leak out of the unit dose article or fall out of the unit dose article. The particles may be dispersed randomly in the x, y, and z axes of the fibrous layers, the particles may be positioned on top of any one or more of the fibrous layers, the particles may be positioned in between plies, and so forth. The respective surfaces of the portions of the plies where the plies are joined may be devoid of particles such as not to affect the joining, or sealing, of the plies. By superposed it is meant that one ply is positioned above or below the other ply with the possibility that additional plies or other materials, for example active agents, may be positioned between the superposed plies. A portion of a first ply may be joined to a portion of a second ply to form a water-soluble unit dose article. By joined it is meant that the elements are attached or connected directly to one another or are attached or connected to one another indirectly through one or more intermediate elements that are attached or connected to the element being referred to as joined. Each ply may comprise one or more fibrous layers. Each of the water-soluble first ply and the water-soluble second ply may comprise one or more fibrous layers, wherein at least one of the one or more fibrous layers of the water-soluble first ply and/or at least one of the one or more fibrous layers of the water-soluble second ply may be a particle-fiber composite layer comprising the plurality of particles.

Particle-fiber composite layers may be formed by providing a solution of filament-forming composition, passing the filament-forming composition through one or more die block assemblies comprising a plurality of spinnerets to form a plurality of fibrous elements, associating a plurality of particles provided by a particle source with the fibrous elements to form a particle-fiber composite structure having a mixture of particles and fibrous elements wherein the plurality of particles has a particle size distribution such that the D50 particle size is from about 1 mm to about 4.75 mm as measured according to the Granular Size Distribution Test Method, and subsequently depositing the particle-fiber composite structure onto a collection belt to form the particle-fiber composite layer. The process of forming layers is further described hereinafter.

FIG. 4 is an illustration of a manufacturing line for making a ply, wherein multiple layers can be associated to form plies. As exemplified in FIG. 4, a solution of a filament-forming composition 35 may be provided. The filament-forming composition 35 may comprise one or more filament-forming materials and optionally one or more active agents. The filament-forming composition 35 may be passed through one or more die block assemblies 40 comprising a plurality, of spinnerets 45 to form a plurality of fibrous elements 30 comprising the one or more filament-forming materials and optionally one or more active agents. Multiple die block assemblies 40 can be employed to spin different fibrous lavers of fibrous elements 30. The fibrous elements 30 of different fibrous layers may have compositions that differ from one another or are the same as one another. That is, the filament forming composition 35 provided to one die block assembly 40 can differ compositionally from the filament forming composition 35 provided to another die block assembly 40. The fibrous elements 30 may be deposited on a collection belt 50 moving in a machine direction MD to form a fibrous layer. More than two die block assemblies 40 in series may be provided to form three, four, or any other integer number of fibrous layers in a given ply.

Particles 32 may be introduced into the stream of the fibrous elements 30 between the die block assembly 40 and the collection belt 50. Particles 32 may be fed from a particle receiver onto a particle belt feeder 41, such as a vibratory, belt or screw feeder. The particle belt feeder 41 may be set and controlled to deliver the desired mass of particles 32 into the process. The particle belt feeder 41 may feed an injection system, such as an air knife 42 or other fluidized conveying system, that suspends and directs the particles 32 in an air stream into the fibrous elements 30 to form a mixture of commingled fibrous elements 30 and particles 32 that are subsequently deposited on the collection belt 50 to form a particle-fiber composite layer. Preferably, the particle belt feeder 41 is completely enclosed with the exception of the exit to minimize disruption of the particle feed. Optionally, the particles 32 may be introduced after the fibrous elements 30 are deposited on the collection belt 50. Optionally, the particles 32 may be introduced by gravity and or optionally in between streams of filament-forming composition 35. An air laid forming head or sifter may be used to introduce the particles 3:2. The one or more fibrous layers may form a ply, such as shown in FIG. 4, a first ply 10.

A benefit of having larger-sized particles, such as those of the present disclosure, is the greater control in handling the particles, as generally, the larger the particle the larger in size and likely greater in mass, hence greater momentum in the delivery process. Without wishing to be bound by theory, the smaller in size and lighter in weight the particles, the more difficult the particles are to control during processing as the particles may be deposited or roll elsewhere on the collection belt or might not land on the collection belt at all and fall outside of the boundaries of the forming zone where fibrous elements are collected on the collection belt.

One or more fibrous layers may form plies. More than two die block assemblies in series can be provided to form three, four, or any other integer number of layers in a given ply. Multiple plies and multilayer plies enable the manufacturer to provide for different product benefits in each ply or layer. It is imagined that there may be fibrous layers void of particles and/or other active agents. Such fibrous layers may be beneficial as outer facing surfaces of the water-soluble unit dose article as such surfaces may be convenient to print upon, pleasant to touch, and such that particles or other active agents would not be ruptured or fall off by contact with an outside force.

For example, a first ply can be provided as part of a first continuous ply web comprising multiple layers formed by one or more die block assemblies in series. A second ply can be provided as part of a second continuous ply web comprising multiple layers formed by one or more die block assemblies 40 in series. The first continuous ply web may be formed on a separate surface than the second continuous ply web. The first continuous ply web and the second continuous ply web may be superposed into a multi-ply structure, then cut and joined together to form a water-soluble unit dose article. Alternatively, the first continuous ply web and the second continuous ply web may be cut prior to superposing the two continuous ply webs to separate each continuous ply web into discrete first and second plies that can then be joined to one another.

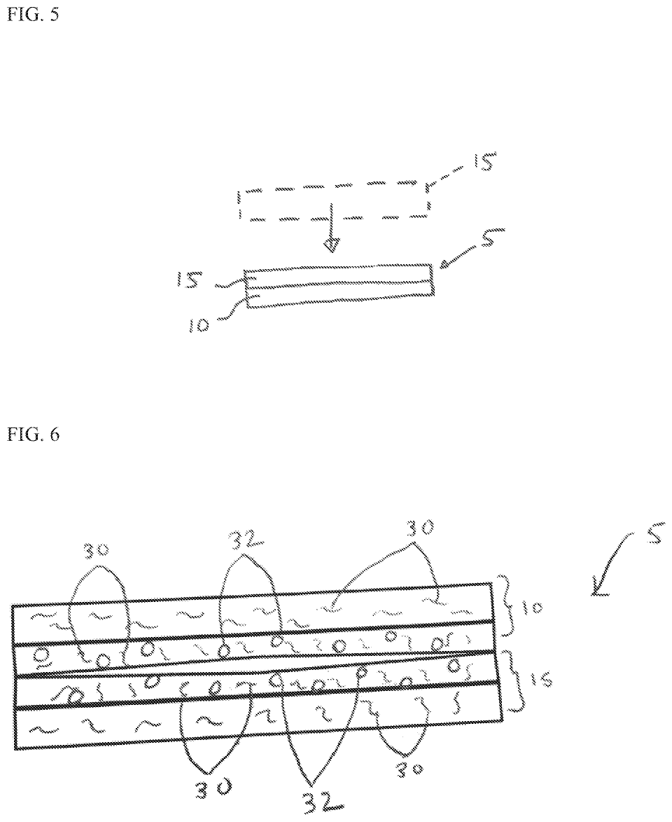

As shown in FIG. 5, a second ply 15 may be joined to a first ply 10 separate the second ply 15, to form a water-soluble unit dose article 5. The first ply 10 and second ply 15 may be superposed relative to one another. The method of making a water-soluble unit dose article 5 may comprise the step of superposing the first ply 10 and the second ply 15, wherein it is meant that the first ply 10 is positioned above or below the second ply 15.

As shown in FIG. 6, a portion of the first ply 10 and a portion of the second ply 15, can be joined to one another, for instance by using a bonding roll, to form the water-soluble unit dose article 5. There may be a third, fourth, fifth, or any number of separate plies contained between the first ply 10 and second ply 15. Optionally, the first ply 10 and the second ply 15 can be joined to a third ply so that the first ply 10 and the second ply 15 are joined to one another through the third ply. Preferably, the two or more plies are joined to one another at the edges of the plies, such as to create an edge seal, such that any particles 32 distributed on top of and/or between fibrous plies and/or within layers do not leak out of the water-soluble unit dose article 5. Sealing may inhibit the leakage of particles 32 as well as to help the water-soluble unit dose article 5 maintain its original structure. The water-soluble unit dose article 5 may be compressed at the point of edge sealing. In a non-limiting example, such as that shown in FIG. 6, the water-soluble unit dose article 5 may comprise a first ply 10 and a second ply 15, wherein each ply comprises two fibrous layers, wherein the multiple plies may be joined (e.g., at the edges) together. In the non-limiting example shown in FIG. 6, the first ply 10 and the second ply 15 each comprise a fibrous layer comprising a plurality fibrous elements 30 and void of particles 32, and a fibrous layer comprising both a plurality of fibrous elements 30 and a plurality of particles 32 (a particle-fiber composite layer). In the non-limiting example shown in FIG. 6, the fibrous layers void of particles 32 are placed as the outward facing surfaces of the water-soluble unit dose article 5 and the particle-fiber composite layers are placed as inward facing surfaces of the water-soluble unit dose article 5.

Plies can be joined, or bonded, to one another by thermal bonding. Thermal bonding can be practical if the plies contain thermoplastic powder, optionally water-soluble thermoplastic material. Thermal bonding can also be practical if the fibers constituting the plies are thermoplastic. Plies can optionally be calendar bonded, point bonded, ultrasonically bonded, infrared bonded, through air bonded, needle punched, hydroentangled, melt bonded, adhesive bonded, or other known technical approach for bonding plies of material.

### A Method of Treating a Substrate

The present disclosure may also encompass a method of treating a substrate using a water-soluble unit dose article according to the present disclosure, the method comprising the steps of: providing a water-soluble unit dose article and contacting the water-soluble unit dose article with one or more substrates to be treated. The method may optionally comprise the steps of adding water to the water-soluble unit dose article to form a wash liquor and contacting the one or more substrates to be treated with the resulting wash liquor. The method may apply as to the treatment of fabrics and any hard surfaces suitable for treatment by the water-soluble unit dose articles of the present disclosure. Hard surfaces suitable for treatment may include, but are not limited to, countertops, tabletops, dishware, toilet bowls, and flooring. The method may be used, for example, as a pre-treatment and/or as a washing treatment. The method may be performed manually, automatically, or a combination of manual and automatic, for instance, when first pre-treating a substrate manually and then undergoing an automatic washing treatment. The steps may be repeated or combined any number of times to result in treated substrates.

The method may be as to treating a fabric, or laundering a fabric. The method may be used, for example, as a pre-treatment and/or as a washing treatment. The method of treating a fabric may be performed manually, such as by hand-laundering, may be performed automatically, by an automatic washing machine, or may be performed as a combination of manually and automatically.

For example, when used as a pre-treatment, a consumer may cut open one or more compartments of the water-soluble unit dose article such that the compositions contained within the one or more compartments of the water-soluble unit dose article are exposed to the atmosphere, and contact the compositions with the substrate to be treated, here, fabric. Alternatively, a consumer may place the water-soluble unit dose article into a receptacle, such as a wash basin, and add water to the water-soluble unit dose article such as to form a wash liquor. The consumer may then place the fabric within the wash basin. The consumer may then rub the compositions into the fabric and/or rub the fabric together with their hands and/or with the same or other fabric and/or with another household care composition external the water-soluble unit dose article. The consumer may agitate the fabric within the wash liquor. The consumer may leave the fabric in contact with the household care composition, in either the concentrated form or within the wash liquor, for any period of time suitable for the fabric to absorb the household care composition (e.g., for about 10 minutes, for about 20 minutes, for about 30 minutes, for about 40 minutes, for about 50 minutes, for about 60 minutes, overnight, and so on). After the consumer has determined that the fabric has sufficiently absorbed the household care composition, the consumer may rinse the household care composition out of the fabric such that the fabric does not feel sticky or any bubbles are left. Alternatively, the consumer may decide not to rinse out the household care composition and progress on to a washing treatment. The pre-treatment of fabric may be performed as a standalone process or may be performed in addition to a washing treatment.

For example, when used as a washing treatment performed automatically by an automatic washing machine, a consumer may place one or more water-soluble unit dose articles into a receptacle, such as a washing machine drum. The consumer may place one or more substrates to be treated, here, fabric, into the receptacle. The consumer may then set a washing treatment cycle on the automatic washing machine such that the automatic washing machine signals for water to be provided into the receptacle, here, a washing machine drum. The water and the water-soluble unit dose article may then form a resulting wash liquor. The fabrics are contacted with the resulting wash liquor. More than one water-soluble unit dose article may be used depending upon numerous factors, such as, for example, the soil level of the fabrics to be washed, the amount of laundry to be washed, and so forth. Any suitable washing machine may be used. Those skilled in the art will recognize suitable machines for the relevant wash operation. The water-soluble unit dose article of the present disclosure may be used in combination with other compositions, such as fabric additives, fabric softeners, rinse aids and the like. The wash temperature may be 30° C. or less. The washing operation may comprise at least one wash cycle having a duration of between 5 and 20 minutes. The automatic laundry machine may comprise a rotating drum, and wherein during at least one wash cycle, the drum has a rotational speed of between 15 and 40 rpm, preferably between 20 and 35 rpm.

For example, when used as a washing treatment performed manually such as handwashing, a consumer may place one or more water-soluble unit dose articles into a receptacle, such as a basin or bucket. The consumer may add water to the water-soluble unit dose article within the receptacle to form a wash liquor. The consumer may place one or more substrates to be treated, here, fabric, into the receptacle and thus into the wash liquor. The consumer may manually agitate the fabric within the wash liquor. The consumer may place one or more substrates to be treated, here, fabric, into the receptacle, then pull out the fabric from the receptacle and rub the fabric together with their hands and/or with the same or other fabric and/or with another surface, such as a washing board.

The method may be as to treating a hard surface, such as dishware. The method may be used, for example, as a pre-treatment and/or as a washing treatment. The method of treating a fabric may be performed manually, such as by hand-dishwashing, may be performed automatically, by an automatic washing machine, or may be performed as a combination of manually and automatically.

For example, when used as a pre-treatment, a consumer may cut open one or more compartments of the water-soluble unit dose article such that the compositions contained within the one or more compartments of the water-soluble unit dose article are exposed to the atmosphere, and contact the compositions with the substrate to be treated, here, dishware. Alternatively, a consumer may place the water-soluble unit dose article into a receptacle, such as a sink or wash basin, and add water to the water-soluble unit dose article such as to form a wash liquor. The consumer may then place the dishware inside of the wash basin or sink. The consumer may then rub the composition into the dishware with their hands and/or with an external cleaning implement such as a sponge and/or with another household care composition external the water-soluble unit dose article. The consumer may leave the dishware in contact with the household care composition, in either the concentrated form or within the wash liquor, for any period of time suitable for the soiled food remnants to absorb the household care composition (e.g., for about 10 minutes, for about 20 minutes, for about 30 minutes, for about 40 minutes, for about 50 minutes, for about 60 minutes, overnight, and so on). After the consumer has determined that the soiled food remnants have sufficiently absorbed the household care composition, the consumer may rinse the household care composition off of the dishware such that the dishware does not feel sticky or any bubbles are left. Alternatively, the consumer may decide not to rinse out the household care composition and progress on to a washing treatment. The pre-treatment of dishware may be performed as a standalone process or may be performed in addition to a washing treatment.

For example, when used as a washing treatment performed automatically by an automatic dishwashing machine, a consumer may place one or more water-soluble unit dose articles into a receptacle, such as a dishwashing machine drum. The consumer may place one or more substrates to be treated, here, dishware, into the receptacle. The consumer may then set a dishwashing treatment cycle on the automatic dishwashing machine such that the automatic dishwashing machine signals for water to be provided into the receptacle, here, a dishwashing machine drum. The water and the water-soluble unit dose article may then form a resulting wash liquor. The dishware is contacted with the resulting wash liquor. Any suitable dishwashing machine may be used. Those skilled in the art will recognize suitable dishwashing machines for the relevant wash operation. The water-soluble unit dose article of the present disclosure may be used in combination with other compositions, such as bleaches, rinse aids and the like. The wash temperature may be between about 45° C. and about 75° C.

For example, when used as a washing treatment performed manually such as hand dishwashing, a consumer may place one or more water-soluble unit dose articles into a receptacle, such as a basin or sink. The consumer may add water to the water-soluble unit dose article within the receptacle to form a wash liquor. The consumer may place one or more substrates to be treated, here, dishware, into the receptacle and thus into the wash liquor. Alternatively, the consumer may not need to place the dishware into the receptacle but may contact the dishware with the wash liquor external the receptacle. The consumer may use their hands and/or an external cleaning implement such as a sponge, dish brush, and/or a towel, to scrub the dishware. The scrubbing step may be performed with the dishware submerged or partially submerged within the wash liquor or external the receptacle, where the dishware is not submerged within the wash liquor. For example, a consumer may soak a sponge within the wash liquor and then contact the surface of the dishware with the sponge and scrub the dishware with the sponge. For example, a consumer may submerge the dishware into the receptacle and into the wash liquor and then scrub the dishware using a sponge while the dishware is submerged, or partially submerged, within the wash liquor.

The method may be as to treating a hard surface, such as flooring or a toilet bowl. The method may be used, for example, as a pre-treatment and/or as a washing treatment. The method of treating flooring or toilet bowls may be performed manually.

For example, when used as a pre-treatment for flooring or toilet bowls, a consumer may cut open one or more compartments of the water-soluble unit dose article such that the compositions contained within the one or more compartments of the water-soluble unit dose article are exposed to the atmosphere, and contact the compositions with the substrate to be treated. Alternatively, a consumer may place the water-soluble unit dose article into a receptacle, such as a wash bucket, and add water to the water-soluble unit dose article such as to form a wash liquor. For flooring, the consumer may then pour the wash liquor onto the flooring and/or use an external cleaning implement, such as a mop or automatic/semi-automatic flooring cleaning machine, to contact the wash liquor with the flooring. For toilet bowls, the consumer may then pour the wash liquor into the toilet bowl and/or use an external cleaning implement, such as a toilet brush, to contact the wash liquor with the surface of the toilet bowl. Alternatively, when the substrate is a toilet bowl, the consumer may choose not to cut open the water-soluble unit dose article, as when the water-soluble unit dose article is placed within the toilet bowl, the water already within the toilet bowl will cause the water-soluble unit dose article to dissolve, forming a wash liquor. The consumer may leave the hard surfaces in contact with the household care composition, in either the concentrated form or with the wash liquor, for any period of time suitable for the any residue to be removed on the hard surface can absorb the household care composition (e.g., for about 10 minutes, for about 20 minutes, for about 30 minutes, for about 40 minutes, for about 50 minutes, for about 60 minutes, overnight, and so on). After the consumer has determined that the residue has sufficiently absorbed the household care composition, the consumer may rinse the household care composition off of the flooring or toilet bowl. Alternatively, the consumer may decide not to rinse out the household care composition and progress on to a washing treatment. The pre-treatment of dishware may be performed as a standalone process or may be performed in addition to a washing treatment. For example, when used as a washing treatment, generally the same steps are performed as the pre-treatment process, however, the consumer may scrub and/or rinse out the composition from the hard surface faster than leaving the composition on the hard surface for undesired residue to absorb. The steps may be repeated or combined any number of times to result in treated hard surfaces. Water-soluble unit dose articles for treating hard surfaces may comprise one or more fibrous structures of the present invention that contains one or more ingredients known in the art of cleaning, for example useful in cleaning hard surfaces, such as an acid constituent, for example an acid constituent that provides good limescale removal performance (e.g., formic acid, citric acid, sorbic acid, acetic acid, boric acid, maleic acid, adipic acid, lactic acid malic acid, malonic acid, glycolic acid, or mixtures thereof). Examples of ingredients that may be included an acidic hard surface cleaning article may include those described in U.S. Pat. No. 7,696,143. Alternatively the hard surface cleaning article comprises an alkalinity constituent (e.g., alkanolamine, carbonate, bicarbonate compound, or mixtures thereof). Examples of ingredients that may be included in an alkaline hard surface cleaning article may include those described in US 2010/0206328 A1.

### Test Methods

### Basis Weight Test Method

Basis weight of a fibrous structure is measured on stacks of twelve usable units using a top loading analytical balance with a resolution of ±0.001 g. The balance is protected from air drafts and other disturbances using a draft shield. A precision cutting die, measuring 3.500 in.±0.0035 in. by 3.500 in.±0.0035 in., is used to prepare all samples.

With a precision cutting die, cut the samples into squares. Combine the cut squares to form a stack twelve samples thick. Measure the mass of the sample stack and record the result to the nearest 0.001 g.

The Basis Weight is calculated in lbs/3000 ft² or g/m² as follows:

Basis Weight=(Mass of stack)/[(Area of 1square in stack)×(No. of squares in stack)]

For example,

Basis Weight (lbs/3000 ft²)=[[Mass of stack (g)/453.6 (g/lbs)]/[12.25 (int)/144 (int/ft²)×12]]×3000

or,

Basis Weight (g/m²)=Mass of stack (g)/[79.032 (cm²)/10,000 (cm²/m²)×12]

Report result to the nearest 0.1 lbs/3000 ft² or 0.1 g/m². Sample dimensions can be changed or varied using a similar precision cutter as mentioned above, so as at least 100 square inches of sample area in stack.

### Diameter Test Method

The diameter of a discrete fibrous element or a fibrous element within a fibrous structure is determined by using a Scanning Electron Microscope (SEM) or an Optical Microscope and an image analysis software. A magnification of 200 to 10,000 times is chosen such that the fibrous elements are suitably enlarged for measurement. When using the SEM, the samples are sputtered with gold or a palladium compound to avoid electric charging and vibrations of the fibrous element in the electron beam. A manual procedure for determining the fibrous element diameters is used from the image (on monitor screen) taken with the SEM or the optical microscope. Using a mouse and a cursor tool, the edge of a randomly selected fibrous element is sought and then measured across its width (i.e., perpendicular to fibrous element direction at that point) to the other edge of the fibrous element. A scaled and calibrated image analysis tool provides the scaling to get actual reading in um. For fibrous elements within a fibrous structure, several fibrous elements are randomly selected across the sample of the fibrous structure using the SEM or the optical microscope. At least two portions of the fibrous structure are cut and tested in this manner. Altogether at least 100 such measurements are made and then all data are recorded for statistical analysis. The recorded data are used to calculate average (mean) of the fibrous element diameters, standard deviation of the fibrous element diameters, and median of the fibrous element diameters.

Another useful statistic is the calculation of the amount of the population of fibrous elements that is below a certain upper limit. To determine this statistic, the software is programmed to count how many results of the fibrous element diameters are below an upper limit and that count (divided by total number of data and multiplied by 100%) is reported in percent as percent below the upper limit, such as percent below 1 micrometer diameter or %-submicron, for example. We denote the measured diameter (in um) of an individual circular fibrous element as di.

In the case that the fibrous elements have non-circular cross-sections, the measurement of the fibrous element diameter is determined as and set equal to the hydraulic diameter which is four times the cross-sectional area of the fibrous element divided by the perimeter of the cross-section of the fibrous element (outer perimeter in case of hollow fibrous elements). The average diameter, alternatively the number-average diameter, is calculated as:

$${d}_{num} = \frac{{\sum }_{i = 1}^{n} {d}_{i}}{n}$$

### Granular Size Distribution Test Method

The granular size distribution test is conducted to determine characteristic sizes of particles. It is conducted using ASTM D 502-89, “Standard Test Method for Particle Size of Soaps and Other Detergents”, approved May 26, 1989, with a further specification for sieve sizes and sieve time used in the analysis. Following section 7, “Procedure using machine-sieving method,” a nest of clean dry sieves containing U.S. Standard (ASTM E11) sieves #4 (4.75 mm), #6 (3.35 mm), #8 (2.36 mm), #12 (1.7 mm), #16 (1.18 mm), #20 (850 um), #30 (600 um), #40 (425 um), #50 (300 um), #70 (212 um), #100 (150 um) is required to cover the range of particle sizes referenced herein. The prescribed Machine-Sieving Method is used with the above sieve nest. A suitable sieve-shaking machine can be obtained from W.S. Tyler Company, Ohio, U.S.A. The sieve-shaking test sample is approximately 100 grams and is shaken for 5 minutes.

The data are plotted on a semi-log plot with the micron size opening of each sieve plotted against the logarithmic abscissa and the cumulative mass percent (Q₃) plotted against the linear ordinate. An example of the above data representation is given in ISO 9276-1:1998, “Representation of results of particle size analysis—Part 1: Graphical Representation”, Figure A.4. A characteristic particle size (Dx), for the purpose of this invention, is defined as the abscissa value at the point where the cumulative mass percent is equal to x percent, and is calculated by a straight-line interpolation between the data points directly above (a) and below (b) the x % value using the following equation:

Dx=10\hat{ }[Log(Da)−(Log(Da)−Log(Db))*(Qa−x %)/(Qa−Qb)]

where Log is the base-10 logarithm, Qa and Qb are the cumulative mass percentile values of the measured data immediately above and below the xth percentile, respectively; and Da and Db are the micron sieve size values corresponding to these data.

### Example Data and Calculations:

| sieve size (um) | weight on sieve (g) | cumulative mass % finer (CMPF) |
|---|---|---|
| 4750 | 0 | 100% |
| 3350 | 0 | 100% |
| 2360 | 0 | 100% |
| 1700 | 0 | 100% |
| 1180 | 0.68 | 99.3% |
| 850 | 10.40 | 89.0% |
| 600 | 28.73 | 60.3% |
| 425 | 27.97 | 32.4% |
| 300 | 17.20 | 15.2% |
| 212 | 8.42 | 6.8% |
| 150 | 4.00 | 2.8% |
| pan | 2.84 | 0.0% |

For D10 (x=10%), the micron screen size where CMPF is immediately above 10% (Da) is 300 μm, the screen below (Db) is 212 μm. The cumulative mass immediately above 10% (Qa) is 15.2%, below (Qb) is 6.8%.

D10=10\hat{ }[Log(300)−(Log(300)−Log(212))*(15.2%−10%)/(15.2%−6.8%)]=242 um

For D50 (x=50%), the micron screen size where CMPF is immediately above 50% (Da) is 1180 μm, the screen below (Db) is 850 μm. The cumulative mass immediately above 90% (Qa) is 99.3%, below (Qb) is 89.0%.

D50=10\hat{ }[Log(600)−(Log(600)−Log(425))*(60.3%−50%)/(60.3%−32.4%)]=528 um

For D90 (x=90%), the micron screen size where CMPF is immediately above 90% (Da) is 600 μm, the screen below (Db) is 425 μm. The cumulative mass immediately above 50% (Qa) is 60.3%, below (Qb) is 32.4%.

D90=10\hat{ }[Log(1180)−(Log(1180)−Log(850))*(99.3%−90%)/(99.3%−89.0%)]=878 um

### Thickness Test Method

Thickness of a fibrous structure is measured by cutting five samples of a fibrous structure sample such that each cut sample is larger in size than a load foot loading surface of a VIR Electronic Thickness Tester Model II available from Thwing-Albert Instrument Company, Philadelphia, Pa., USA. Typically, the load foot loading surface has a circular surface area of about 3.14 int. The sample is confined between a horizontal flat surface and the load foot loading surface. The load foot loading surface applies a confining pressure to the sample of 15.5 g/cm². The thickness of each sample is the resulting gap between the flat surface and the load foot loading surface. The thickness is calculated as the average thickness of the five samples. The result is reported in millimeters (mm).

### Water Content Test Method

The water (moisture) content present in a particle and/or a fibrous structure is measured using the following Water Content Test Method. A particle or portion thereof (“sample”) in the form of a pre-cut sheet is placed in a conditioned room at a temperature of 23° C.±1.0° C. and a relative humidity of 50%±2% for at least 24 hours prior to testing. Each structure sample has an area of at least 4 square inches, but small enough in size to fit appropriately on the balance weighing plate. Under the temperature and humidity conditions mentioned above, using a balance with at least four decimal places, the weight of the sample is recorded every five minutes until a change of less than 0.5% of previous weight is detected during a 10-minute period. The final weight is recorded as the “equilibrium weight”. Within 10 minutes, the sample is placed into the forced air oven on top of foil for 24 hours at 70° C.±2° C. at a relative humidity of 4%±2% for drying. After the 24 hours of drying, the sample is removed and weighed within 15 seconds. This weight is designated as the “dry weight” of the sample.

The water (moisture) content of the sample is calculated as follows:

$$\% wt . water in sample = 100 \% \times \frac{( Equilibrium weight of sample - Dry weight of sample )}{Dry weight of sample}$$

The % wt. water (moisture) in sample for 3 replicates is averaged to give the reported % wt. water (moisture) in sample. Results are reported to the nearest 0.1%.

### EXAMPLES

### Example 1

As illustrated in FIG. 4, described above, a solution of a filament-forming composition 35 may be provided and passed through a die block assembly 40 having a first spinneret 45 to form a plurality of fibrous elements 30. The fibrous elements 30 may be deposited on a collection belt 50. A second spinneret 45 may be located downstream the first spinneret 45, the second spinneret 45 forming another plurality of fibrous elements 30. The collection belt 50 having the first layer of fibrous elements 30 may move in the machine direction MD passing underneath a particle belt feeder 41 and an injection system, such as an air knife 42. The particle belt feeder 41 and injection system may be capable of substantially injecting particles 32 towards a landing zone on the collection belt 50 that is directly under the fibrous elements 30 from the second spinneret 45.

Table 1 below sets forth non-limiting sample formulations of dried fiber compositions of the present disclosure, which may be used to make the fibrous elements. To make the fibrous elements, an aqueous solution, preferably having about 45% to 60% solids content, is processed through one or more spinnerets 45 as shown in FIG. 4. A suitable spinneret 45 comprises a die block assembly 40 with attenuation airflow, along with drying airflow suitable to substantially dry the attenuated fibrous elements 30 before their impingement on the collection belt 50. The below examples are illustrative. Amounts are provided as weight percent, by weight of the composition.

TABLE 1
Fiber (F) Compositions, mass %:

| Component | F1 | F2 | F3 | F4 | F5 | F6 |
|---|---|---|---|---|---|---|
| LAS | 48.5 | 43.1 | 59.2 | 21.0 | 47.2 | 51.8 |
| AS | 0.0 | 21.6 | 0.0 | 42.0 | 23.6 | 12.9 |
| AES | 16.2 | 0.0 | 0.0 | 0.0 | 0.0 | 0.0 |
| PEG-PVAc | 0.0 | 0.0 | 5.9 | 3.2 | 0.0 | 0.0 |
| PVOH | 32.3 | 29.3 | 28.5 | 27.5 | 23.7 | 29.3 |
| PEO | 0.0 | 3.0 | 3.2 | 3.2 | 2.5 | 3.0 |
| Moist & balance | 3.0 | 3.0 | 3.2 | 3.1 | 3.0 | 3.0 |
| Total | 100 | 100 | 100 | 100 | 100 | 100 |

Table 2 below sets forth non-limiting sample formulations of particle compositions of the present disclosure. Particles may be made by a variety of suitable processes including milling, spray-drying, agglomeration, extrusion, prilling, encapsulation, pastillization and any combination thereof. One or more particles may be mixed together before adding. The below examples are illustrative. Amounts are provided as weight percent, by weight of the composition. The particles of Table 2 are of particles having a particle size distribution such that the D50 particle size is from about 1 mm to about 4.75 mm, as measured according to the Granular Size Distribution Test Method.

TABLE 2
Particle (P) Compositions, mass %:

| Component | P1 | P2 | P3 | P4 | P5 | P6 | P7 | P8 | P9 | P10 | P11 | P12 |
|---|---|---|---|---|---|---|---|---|---|---|---|---|
| LAS | 0.0 | 0.0 | 7.6 | 9.5 | 8.1 | 10.8 | 4.4 | 17.2 | 13.7 | 19.2 | 20.8 | 5.0- |
| | | | | | | | | | | | | 20.0 |
| AS | 19.2 | 0.0 | 0.0 | 0.0 | 0.0 | 0.0 | 0.0 | 0.0 | 0.0 | 0.0 | 1.1 | 0.0- |
| | | | | | | | | | | | | 20.0 |
| AES | 4.8 | 45.0 | 26.4 | 21.6 | 24.6 | 21.6 | 26.3 | 34.3 | 27.4 | 25.7 | 26.6 | 4.0- |
| | | | | | | | | | | | | 50.0 |
| Sodium Carb. | 18.0 | 35.0 | 19.2 | 15.3 | 15.1 | 10.0 | 14.2 | 21.6 | 21.7 | 20.6 | 22.2 | 10.0- |
| | | | | | | | | | | | | 35.0 |
| Zeolite-A | 54.2 | 0.0 | 24.4 | 32.0 | 49.1 | 51.8 | 49.9 | 0.0 | 0.0 | 0.0 | 0.0 | 0.0- |
| | | | | | | | | | | | | 55.0 |
| Chelant | 0.0 | 0.0 | 0.0 | 0.0 | 0.0 | 0.0 | 0.0 | 0.0 | 0.0 | 3.5 | 0.0 | 0.0- |
| | | | | | | | | | | | | 3.5 |
| PE20 | 0.0 | 0.0 | 10.4 | 3.7 | 0.0 | 3.5 | 0.0 | 3.5 | 1.6 | 3.4 | 3.4 | 0.0- |
| | | | | | | | | | | | | 11.0 |
| PLURONIC ® | 0.0 | 0.0 | 0.0 | 0.0 | 0.0 | 0.0 | 1.8 | 0.0 | 0.0 | 0.0 | 0.0 | 0.0- |
| F38 | | | | | | | | | | | | 2.0 |
| Disp. Polymer | 0.0 | 0.0 | 0.0 | 0.0 | 0.0 | 0.0 | 0.0 | 0.0 | 16.5 | 8.1 | 8.4 | 0.0- |
| | | | | | | | | | | | | 17.0 |
| PEG4000 | 0.8 | 0.0 | 0.0 | 8.2 | 0.0 | 0.0 | 0.0 | 0.0 | 0.0 | 0.0 | 0.0 | 0.0- |
| | | | | | | | | | | | | 9.0 |
| Silica | 0.0 | 15.0 | 8.2 | 6.7 | 0.0 | 0.0 | 0.0 | 20.2 | 14.5 | 16.4 | 12.3 | 0.0- |
| | | | | | | | | | | | | 21.0 |
| PVOH + PEO | 0.0 | 0.0 | 0.0 | 0.0 | 0.0 | 0.0 | 0.0 | 0.0 | 0.0 | 0.0 | 1.7 | 0.0- |
| | | | | | | | | | | | | 1.7 |
| Bleach system & | 0.0 | 0.0 | 0.0 | 0.0 | 0.0 | 0.0 | 0.0 | 0.0 | 0.0 | 0.0 | 0.0 | 0.5- |
| bleach activator | | | | | | | | | | | | 5.0 |
| Moist & balance | 3.0 | 5.0 | 3.8 | 3.0 | 3.1 | 2.3 | 3.3 | 3.2 | 4.6 | 3.1 | 3.5 | Bal. |
| Total | 100 | 100 | 100 | 100 | 100 | 100 | 100 | 100 | 100 | 100 | 100 | 100 |

Resulting products, water-soluble unit dose articles, are exemplified in Table 3, providing structural detail for product chasses by fiber and particle components (from Tables 1 and 2, respectively), with the net chassis composition for the product. Note that other product adjunct materials such as perfume, enzymes, suds suppressor, bleaching agents, etc. may be added to a chassis. In the illustrative example chasses below, each chassis is composed of two plies.

Chasses exemplify a range of detergent products having particles of the present disclosure. The below examples are illustrative.

TABLE 3
Product Chasses (C)

| Chassis | C1 | C2 | C3 | C4 | C5 | C6 | C7 | C8 | C9 | C10 |
|---|---|---|---|---|---|---|---|---|---|---|
| Fiber type | F1 | F2 | F2 | F2 | F2 | F2 | F2 | F2 | F6 | F2 |
| Fiber wt % | 25% | 25% | 25% | 28% | 17% | 27% | 26% | 21% | 22% | 27% |
| Particle type | P1 | P1 | P2 | P3 | P3 | P4 | P5 | P6 | P7 | P8 |
| Particle wt % | 75% | 75% | 75% | 72% | 83% | 73% | 74% | 79% | 78% | 73% |
| Basis wt, gsm | 4876 | 4878 | 3339 | 3892 | 6396 | 4557 | 4054 | 4252 | 4788 | 4557 |
| Formula, g/dose: | | | | | | | | | | |
| LAS | 2.5 | 2.2 | 1.5 | 3.0 | 3.6 | 3.6 | 2.9 | 3.1 | 3.0 | 4.2 |
| AS | 2.5 | 3.6 | 0.8 | 1.0 | 1.0 | 1.1 | 1.0 | 0.8 | 1.0 | 1.1 |
| AES | 2.0 | 1.2 | 4.7 | 3.0 | 5.9 | 3.0 | 3.1 | 3.1 | 3.7 | 3.8 |
| Sodium Carb. | 2.8 | 2.8 | 3.7 | 2.1 | 4.3 | 2.1 | 1.9 | 1.4 | 1.4 | 3.0 |
| Zeolite-A | 8.4 | 8.4 | 0.0 | 2.8 | 5.5 | 4.5 | 6.2 | 7.5 | 7.5 | 0.0 |
| Silica | 0.0 | 0.0 | 1.6 | 1.0 | 2.0 | 1.0 | 0.0 | 0.0 | 0.0 | 2.3 |
| PEG4000 | 0.1 | 0.1 | 0.0 | 0.0 | 0.0 | 1.1 | 0.0 | 0.0 | 0.0 | 0.0 |
| PE20 | 0.0 | 0.0 | 0.0 | 1.5 | 2.3 | 0.5 | 0.0 | 0.3 | 0.0 | 0.2 |
| PLURONIC ® | 0.0 | 0.0 | 0.0 | 0.0 | 0.0 | 0.0 | 0.0 | 0.0 | 0.3 | 0.0 |
| F38 | | | | | | | | | | |
| Disp. polymer | 0.0 | 0.0 | 0.0 | 0.0 | 0.0 | 0.0 | 0.0 | 0.0 | 0.0 | 2.3 |
| PVOH + PEO | 1.7 | 1.7 | 1.1 | 1.5 | 1.4 | 1.7 | 1.4 | 1.2 | 1.5 | 1.7 |
| Moist & balance | 0.5 | 0.5 | 0.6 | 0.5 | 0.8 | 0.5 | 0.5 | 0.4 | 0.6 | 0.5 |
| Total chassis | 20.5 | 20.5 | 14.0 | 16.4 | 26.8 | 19.1 | 17.0 | 17.8 | 19.0 | 19.1 |

### Raw Materials for Example 1

LAS may be a linear alkylbenzene sulfonate having an average aliphatic carbon chain length C₁₁-C₁₂ such as those commercially available by Stepan (Northfield, Ill., USA) or from Huntsman Corp. HLAS is acid form.

AES may be a C₁₂₋₁₄ alkyl ethoxy (3) sulfate, C₁₄₋₁₅ alkyl ethoxy (2.5) sulfate, or C₁₂₋₁₅ alkyl ethoxy (1.8) sulfate, such as those commercially available from Stepan (Northfield, Ill., USA) or from Shell Chemicals (Houston, Tex., USA).

AS may be a C₁₂₋₁₄ sulfate, such as those commercially available by Stepan, Northfield, Ill., USA, and/or a mid-branched alkyl sulfate.

Dispersant Polymer (Disp. Polymer) may have an acrylate:maleate ratio 70:30, such as those supplied by BASF (Cincinnati, Ohio, USA).

PEG-PVAc polymer is a polyvinyl acetate grafted polyethylene oxide copolymer having a polyethylene oxide backbone and multiple polyvinyl acetate side chains. The weight average molecular weight of the polyethylene oxide backbone is about 6000 and the weight ratio of the polyethylene oxide to polyvinyl acetate is about 40 to 60 and no more than 1 grafting point per 50 ethylene oxide units. Such polymers include those commercially available from BASF USA (Cincinnati, Ohio, USA).

PE20 may be an ethoxylated polyethylenimine having polyethylenimine core with 20 ethoxylate groups per —NH. Such ethoxylated polyethylenimines may include those commercially available from BASF USA (Cincinnati, Ohio, USA).

Bleach activators may be selected from the group consisting of: nonanoyloxybenzene sulfonate (NOBS), tetraacetylethylenediamine (TAED), acyl hydrazine, amido-derived bleach activators, and mixtures thereof. Amido-derived bleach activators may include but are not limited to (6-octanamidocaproyl)oxybenzenesulfonate, (6-25 nonanamidocaproyl)oxybenzenesulfonate, and (6-decanamidocaproyl)oxybenzenesulfonate.

Balance may include any additional actives plus residual moisture, process aids, and trace salt and unreacted alcohols in surfactant paste.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

For clarity purposes, the total “% wt” values do not exceed 100% wt.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular examples and/or embodiments of the present disclosure have been illustrated, and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A water-soluble unit dose article comprising a water-soluble fibrous structure and a plurality of particles associated with the water-soluble fibrous structure, wherein the plurality of particles has a particle size distribution such that the D50 particle size is from about 1 mm to about 4.75 mm, as measured according to the Granular Size Distribution Test Method, and wherein the water-soluble fibrous structure further comprises a plurality of fibrous elements.

2. The water-soluble unit dose article according to claim 1, wherein the plurality of particles has a particle size distribution such that the D50 particle size is from about 1.7 mm to about 3.5 mm, as measured according to the Granular Size Distribution Test Method.

3. The water-soluble unit dose article according to claim 1, wherein one or more of the particles is water-soluble.

4. The water-soluble unit dose article according to claim 1, wherein one or more of the particles comprises from about 3% to about 95%, by weight of the particle, of an active agent.

5. The water-soluble unit dose article according to claim 4, wherein the active agent is selected from the group consisting of a surfactant, a structurant, a builder, an organic polymeric compound, a polymeric dispersing agent, an enzyme, an enzyme stabilizer, a bleach system, a brightener, a hueing agent, a chelating agent, a suds suppressor, a suds booster, a dye transfer inhibiting agent, a conditioning agent, a perfume, an encapsulate comprising a laundry care adjunct, a buffer, an alkanolamine, and mixtures thereof.

6. The water-soluble unit dose article according to claim 1, wherein one or more of the particles comprises an active agent, wherein the active agent comprises a bleach system, and wherein the bleach system comprises a bleach activator selected from the group consisting of nonanoyloxybenzene sulfonate (NOBS), tetraacetylethylenediamine (TAED), acyl hydrazine, amido-derived bleach activators, and mixtures thereof.

7. The water-soluble unit dose article according to claim 1, wherein one or more of the particles comprises an active agent, wherein the active agent comprises a surfactant, wherein the surfactant is selected from the group consisting of anionic surfactants, cationic surfactants, nonionic surfactants, zwitterionic surfactants, amphoteric surfactants, and mixtures thereof.

8. The water-soluble unit dose article according to claim 1, wherein at least about 10% of the particles comprise an alkyl alkoxy sulfate surfactant.

9. The water-soluble unit dose article according to claim 1, wherein one or more of the particles comprises an active agent, wherein the active agent comprises a polymeric dispersing agent.

10. The water-soluble unit dose article according to claim 1, wherein one or more of the particles releasably comprises an active agent selected from the group consisting of a surfactant, a structurant, a builder, an organic polymeric compound, a polymeric dispersing agent, an enzyme, an enzyme stabilizer, a bleach system, a brightener, a hueing agent, a chelating agent, a suds suppressor, a suds booster, a dye transfer inhibiting agent, a conditioning agent, a perfume, an encapsulate comprising a laundry care adjunct, a buffer, an alkanolamine, and mixtures thereof.

11. The water-soluble unit dose article according to claim 1, wherein the water-soluble unit dose article further comprises a plurality of smaller-sized particles associated with the water-soluble fibrous structure, wherein the plurality of smaller-sized particles has a particle size distribution such that the D50 particle size is from about 0.001 mm to about 0.9 mm, as measured according to the Granular Size Distribution Test Method.

12. The water-soluble unit dose article according to claim 1, wherein the plurality of particles comprises no more than about 10%, by weight of the particle, of water, as measured according to the Water Content Test Method.

13. The water-soluble unit dose article according to claim 1, wherein one or more of the fibrous elements comprises from about 5% to about 80%, by weight on a dry fibrous element basis, of a filament-forming material.

14. The water-soluble unit dose article according to claim 1, wherein one or more of the fibrous elements comprises a filament-forming material selected from the group consisting of pullulan, hydroxypropylmethyl cellulose, hydroxyethyl cellulose, hydroxypropyl cellulose, polyvinyl pyrrolidone, sodium alginate, xanthan gum, tragacanth gum, guar gum, acacia gum, Arabic gum, polyacrylic acid, methylmethacrylate copolymer, carboxyvinyl polymer, dextrin, pectin, chitin, levan, elsinan, collagen, gelatin, zein, gluten, soy protein, casein, polyvinyl alcohol (PVOH), carboxylated polyvinyl alcohol (PVOH), sulfonated polyvinyl alcohol (PVOH), starch, starch derivatives, hemicellulose, hemicellulose derivatives, proteins, chitosan, chitosan derivatives, polyethylene glycol, tetramethylene ether glycol, hydroxymethyl cellulose, carboxymethylcellulose, polyethylene oxide (PEO), hydroxyl-containing polymers and their derivatives, and mixtures thereof.

15. The water-soluble unit dose article according to claim 1, wherein one or more of the fibrous elements comprises from about 5% to about 95%, by weight on a dry fibrous element basis, of an active agent.

16. The water-soluble unit dose article according to claim 15, wherein the active agent is selected from the group consisting of a surfactant, a structurant, a builder, an organic polymeric compound, a polymeric dispersing agent, an enzyme, an enzyme stabilizer, a bleach system, a brightener, a hueing agent, a chelating agent, a suds suppressor, a suds booster, a dye transfer inhibiting agent, a conditioning agent, a perfume, an encapsulate comprising a laundry care adjunct, a buffer, an alkanolamine, and mixtures thereof.

17. The water-soluble unit dose article according to claim 1, wherein one or more of the fibrous elements releasably comprises an active agent.

18. A method of making a water-soluble unit dose article, the method comprising the steps of:
a. providing a water-soluble first ply;
b. providing a water-soluble second ply, wherein the water-soluble second ply is separate from the water-soluble first ply;
c. providing a plurality of particles;
d. associating the plurality of particles with the water-soluble first ply and/or the water-soluble second ply;
e. superposing the water-soluble first ply and the water-soluble second ply; and
f. joining a portion of the water-soluble first ply to a portion of the water-soluble second ply to form the water-soluble unit dose article, wherein the plurality of particles is contained within the water-soluble unit dose article;
wherein the plurality of particles has a particle size distribution such that the D50 particle size is from about 1 mm to about 4.75 mm, as measured according to the Granular Size Distribution Test Method.

19. The method of making a water-soluble unit dose article according to claim 18, wherein each of the water-soluble first ply and the water-soluble second ply comprises one or more fibrous layers, wherein at least one of the one or more fibrous layers of the water-soluble first ply and/or at least one of the one or more fibrous layers of the water-soluble second ply is a particle-fiber composite layer comprising the plurality of particles.

20. A method of treating a substrate using a water-soluble unit dose article, the method comprising the steps of: providing a water-soluble unit dose article and contacting the water-soluble unit dose article with one or more substrates to be treated, wherein the water-soluble unit dose article comprises a water-soluble fibrous structure and a plurality of particles associated with the water-soluble fibrous structure, wherein the plurality of particles has a particle size distribution such that the D50 particle size is from about 1 mm to about 4.75 mm, as measured according to the Granular Size Distribution Test Method, and wherein the water-soluble fibrous structure further comprises a plurality of fibrous elements.
